(19) United States
(12) Patent Application Publication
(10) Pub. No.: US 2016/0323248 A1
(43) Pub. Date: Nov. 3, 2016

(54) METHODS, APPARATUS, SYSTEMS AND MECHANISMS FOR SECURE ATTRIBUTE BASED FRIEND FIND AND PROXIMITY DISCOVERY

(71) Applicant: INTERDIGITAL PATENT HOLDINGS INC., Wilmington, DE (US)

(72) Inventor: Eldad M. Zeira, Huntington, NY (US)

(21) Appl. No.: 15/108,712

(22) PCT Filed: Dec. 30, 2014
(86) PCT No.: PCT/US2014/072626

§ 371 Date: Jun. 28, 2016

Related U.S. Application Data
(60) Provisional application No. 61/922,270, filed on Dec. 31, 2013.

(51) Int. Cl. H04L 29/06; G06F 17/30; H04W 4/20; H04W 4/08; H04L 29/08

(52) U.S. Cl. CPC H04L 63/0421; H04W 4/08; H04L 67/306; H04W 4/206; G06F 17/30979; H04L 63/0428

(57) ABSTRACT

Methods, apparatus and system for managing a group of users operating on one or more networks are disclosed. One method includes determining whether a second user is a user of interest; and forming the group of users based on at least the determination. A second method includes sending, in an initial stage first anonymized information of the first user to enable a second user to determine whether the first user is of interest to the second user; on condition that the first user is of interest to the second user, receiving, in the initial stage, second anonymized information of the second user to enable the first user to determine whether the second user is of interest to the first user; on condition that the second user is of interest to the first user, sending, in second stage, first non-anonymized information of the first user to enable the second user to form a group with the first user; and on condition that the first user is of interest to the second user, receiving, in the second stage, second non-anonymized information of the second user to enable the first user to form the group with the second user.

### FIELD OF THE INVENTION

The present invention relates to the field of wired and wireless communications and, more particularly, to methods, apparatus, systems and mechanisms that, alone or in combination, allow two or more applications, for example: to exchange user information (e.g., in a secure and controlled manner), to compare user information based on rules and/or a dictionary, to connect users based on matching criteria, and/or to provide proximity detection.

### BACKGROUND OF THE INVENTION

3GPP is developing proximity services (ProSe) for LTE. Many features associated with ProSe are expected to be included in 3GPP Release-12. ProSe features may be used for discovery of and communications between Public Safety users. It also may be used commercially for discovery (“presence”) of users in proximity to each other and/or as an initial step in setting up peer to peer communication paths between two UEs that does not pass through network nodes. As such, it could provide users with enhanced QoS and operators with the ability to offload traffic. Furthermore, network operators may be able to charge for features associated with the use of ProSe by their customers/users (e.g. discoverability, discovery events, enhanced QoS service, etc.).

LTE direct Device to Device (D2D) link, WiFi Direct™, other WLAN-based protocols, or local forwarding (e.g., through an eNode-B) may be used for ProSe.

The 3GPP ProSe architecture will likely be executed and managed by the mobile network (MN) under the control of the mobile network operator (MNO) and will likely include at least one server in the Evolved Packet Core (EPC) and supporting functionality in a variety of other EPC servers. The above is valid whether LTE or WLAN is used for D2D. Inter-PLMN (Public Land Mobile Network) discovery will be supported by ProSe, but inter-application operation (i.e. that involves two application servers) is beyond the scope of 3GPP.

Social networking is one of the significant uses of both wired and radio communications and is only expected to grow in the coming years, particularly in radio/wireless communications systems. There are many social networking applications in common use today. Some such social networking applications include Facebook, Twitter, Myspace, and LinkedIn.

### SUMMARY OF THE INVENTION

In certain representative embodiments, pairing or grouping mechanisms may be implemented. For example, representative mechanisms may include grouping (and/or pairing) of users of different applications based on users' profiles.

In certain representative embodiments, the representative mechanisms may enable different applications to interact directly between themselves and to search for matches in each other's user profiles such that a user's identity may be anonymized throughout the information exchange.

In certain representative embodiments, after initially anonymizing the information exchanged, an application-defined identity may be released, for example, upon a determination of a sufficient match and/or after user consent. User consent may be a query of the user via a user interface. For example, an identity provider (e.g., a third party) may be used for the anonymized identity. In certain representative embodiments, both sides of the exchange may agree or may be required to agree to their identity disclosure prior to such an exchange of information (e.g., before permanent identity exchange may take place).

In certain representative embodiments, representative mechanisms may be implemented to group (or pair) users through an untrustworthy Broker (e.g., that may be defined herein as an entity that may not or cannot be trusted with at least some information in an exchange (e.g., one or more users' identities, attributes and/or other information). The Broker may match the users of applications that are not known to each other.

In certain representative embodiments, representative mechanisms may be implemented to group (or pair) users between untrustworthy applications through a trustworthy Broker.

In certain representative embodiments, representative mechanisms may be implemented to determine, for example, if users are in logical proximity with each other (e.g., whether they are accessible, for example, within a network (e.g., an mobile network (MN)) or within networks (e.g., the Internet via the MN).

In certain representative embodiments, representative mechanisms may be implemented to determine, for example, if users are in physical proximity (e.g., using either a 3GPP standardized and/or an over-the-top procedure, among others).

In certain representative embodiments, representative mechanisms may be implemented to compare profiles of two or more users. The profiles may include: (1) profiles composed of or including sentences with some pre-determined syntax; and/or (2) profiles that use descriptors whose equivalency may be determined by a dictionary of synonyms.

In certain representative embodiments, proximity services (ProSe, and/or 3GPP based ProSe) may be used for Long Term Evolution (LTE) systems. For example, ProSe (which may include discoverability procedures, discovery events procedures, and/or enhanced QoS services, among other) may be used for discovery of and communications between public safety users and/or may be used commercially for discovery (to determine a presence) and/or an alternative path between UEs for UE-UE communications that may not pass through core network nodes. For example, the ProSe may provide users with enhanced QoS and operators with the ability to offload traffic. ProSe discovery may determine whether a certain user (e.g., a friend of interest (FOI)) is or may be in proximity (e.g., logical and/or physical proximity).

In certain representative embodiments, discovery procedures may be implemented to enable user exchanges for proximate users and/or for users which may not be logically and/or physically proximate.

In certain representative embodiments, LTE direct Device to Device link, WiFi Direct™ (or other WLAN based protocols) and/or local forwarding (e.g., through a Node-B, or other access point) may be used for ProSe.

In certain representative embodiments, a ProSe architecture may be executed and/or managed by the MN under the control of the Mobile Network Operator (MNO). Inter-PLMN discovery may be provided by ProSe procedures.

In this specification, the term “application” refers to a service providing entity that may be installed on a server and/or the mobile telephone and may have access to and control of a database of profiles.

### BRIEF DESCRIPTION OF THE DRAWINGS

A more detailed understanding may be had from the Detailed Description of the Invention below, given by way of example in conjunction with drawings appended hereto. Figures in such drawings, like the detailed description, are examples. As such, the Figures and the detailed description are not to be considered limiting, and other equally effective examples are possible and likely. Furthermore, like reference numerals in the Figures indicate like elements, and wherein:

FIG. 1 is a system diagram illustrating an example communications system in which one or more disclosed embodiments may be implemented;

FIG. 2 is a system diagram illustrating an example wireless transmit/receive unit (WTRU) that may be used within the communications system illustrated in FIG. 1;

FIG. 3 is a system diagram illustrating an example radio access network and another example core network that may be used within the communications system illustrated in FIG. 1;

FIG. 4 is a system diagram illustrating another example radio access network and another example core network that may be used within the communications system illustrated in FIG. 1;

FIG. 5 is a system diagram illustrating a further example radio access network and a further example core network that may be used within the communications system illustrated in FIG. 1;

FIG. 6 is a diagram illustrating a representative architecture for applications which provide proximity notifications;

FIG. 7 is a diagram illustrating a typical example network architecture in accordance with an embodiment of the invention;

FIGS. 8A, 8B, and 8C collectively comprise a message flow diagram illustrating message flow for in accordance with one exemplary embodiment of the invention; and

FIGS. 9A, 9B, and 9C collectively comprise a message flow diagram illustrating message flow for in accordance with another exemplary embodiment of the invention.

### DETAILED DESCRIPTION OF THE INVENTION

A detailed description of illustrative embodiments may now be described with reference to the figures. However, while the present invention may be described in connection with representative embodiments, it is not limited thereto and it is to be understood that other embodiments may be used or modifications and additions may be made to the described embodiments for performing the same function of the present invention without deviating therefrom.

### I. REPRESENTATIVE NETWORKS AND EQUIPMENT

Although the representative embodiments are generally shown hereafter using wireless network architectures, any number of different network architectures may be used including networks with wired components and/or wireless components, for example.

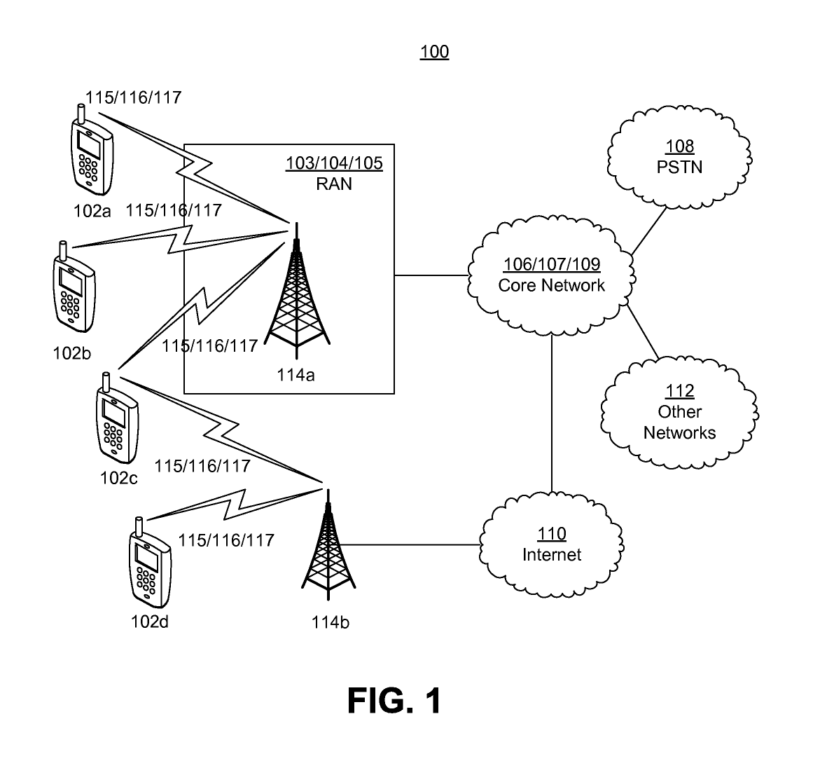

FIG. 1 is a diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), and the like.

As shown in FIG. 1, the communications system 100 may include wireless transmit/receive units (WTRUs) 102a, 102b, 102c, 102d, a radio access network (RAN) 103/104/105, a core network 106/107/109, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d may be configured to transmit and/or receive wireless signals and may include user equipment (UE), a mobile station, a fixed or mobile subscriber unit, a pager, a cellular telephone, a personal digital assistant (PDA), a smartphone, a laptop, a netbook, a personal computer, a wireless sensor, consumer electronics, and the like. The WTRU 102a, 102b, 102c and 102d is interchangeably referred to as a UE.

The communications systems 100 may also include a base station 114a and/or a base station 114b. Each of the base stations 114a, 114b may be any type of device configured to wirelessly interface with at least one of the WTRUs 102a, 102b, 102c, 102d to facilitate access to one or more communication networks, such as the core network 106/107/109, the Internet 110, and/or the other networks 112. By way of example, the base stations 114a, 114b may be a base transceiver station (BTS), a Node-B, an eNode-B, a Home Node B, a Home eNode-B, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 103/104/105, which may also include other base stations and/or network elements (not shown), such as a base station controller (BSC), a radio network controller (RNC), relay nodes, etc. The base station 114a and/or the base station 114b may be configured to transmit and/or receive wireless signals within a particular geographic region, which may be referred to as a cell (not shown). The cell may further be divided into cell sectors. For example, the cell associated with the base station 114a may be divided into three sectors. Thus, in one embodiment, the base station 114a may include three transceivers, e.g., one for each sector of the cell. In another embodiment, the base station 114a may employ multiple-input multiple output (MIMO) technology and may utilize multiple transceivers for each sector of the cell.

The base stations 114a, 114b may communicate with one or more of the WTRUs 102a, 102b, 102c, 102d over an air interface 115/116/117, which may be any suitable wireless communication link (e.g., radio frequency (RF), microwave, infrared (IR), ultraviolet (UV), visible light, etc.). The air interface 115/116/117 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 103/104/105 and the WTRUs 102a, 102b, 102c may implement a radio technology such as Universal Mobile Telecommunications System (UMTS) Terrestrial Radio Access (UTRA), which may establish the air interface 115/116/117 using wideband CDMA (WCDMA). WCDMA may include communication protocols such as High-Speed Packet Access (HSPA) and/or Evolved HSPA (HSPA+). HSPA may include High-Speed Downlink (DL) Packet Access (HSDPA) and/or High-Speed UL Packet Access (HSUPA).

In another embodiment, the base station 114a and the WTRUs 102a, 102b, 102c may implement a radio technology such as Evolved UMTS Terrestrial Radio Access (E-UTRA), which may establish the air interface 115/116/117 using Long Term Evolution (LTE) and/or LTE-Advanced (LTE-A).

In other embodiments, the base station 114a and the WTRUs 102a, 102b, 102c may implement radio technologies such as IEEE 802.11 (i.e., Wireless Fidelity (WiFi), IEEE 802.16 (i.e., Worldwide Interoperability for Microwave Access (WiMAX)), CDMA2000, CDMA2000 1×, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1 may be a wireless router, Home Node B, Home eNode-B, or access point, for example, and may utilize any suitable RAT for facilitating wireless connectivity in a localized area, such as a place of business, a home, a vehicle, a campus, and the like. In one embodiment, the base station 114b and the WTRUs 102c, 102d may implement a radio technology such as IEEE 802.11 to establish a wireless local area network (WLAN). In another embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, etc.) to establish a picocell or femtocell. As shown in FIG. 1, the base station 114b may have a direct connection to the Internet 110. Thus, the base station 114b may not be required to access the Internet 110 via the core network 106/107/109.

The RAN 103/104/105 may be in communication with the core network 106/107/109, which may be any type of network configured to provide voice, data, applications, and/or voice over internet protocol (VoIP) services to one or more of the WTRUs 102a, 102b, 102c, 102d. For example, the core network 106/107/109 may provide call control, billing services, mobile location-based services, pre-paid calling, Internet connectivity, video distribution, etc., and/or perform high-level security functions, such as user authentication. Although not shown in FIG. 1, it will be appreciated that the RAN 103/104/105 and/or the core network 106/107/109 may be in direct or indirect communication with other RANs that employ the same RAT as the RAN 103/104/105 or a different RAT. For example, in addition to being connected to the RAN 103/104/105, which may be utilizing an E-UTRA radio technology, the core network 106/107/109 may also be in communication with another RAN (not shown) employing a GSM, UMTS, CDMA 2000, WiMAX, or WiFi radio technology.

The core network 106/107/109 may also serve as a gateway for the WTRUs 102a, 102b, 102c, 102d to access the PSTN 108, the Internet 110, and/or the other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another core network connected to one or more RANs, which may employ the same RAT as the RAN 103/104/105 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1 may be configured to communicate with the base station 114a, which may employ a cellular-based radio technology, and with the base station 114b, which may employ an IEEE 802 radio technology. Some or all of the WTRUs 102a, 102b, 102c, 102d in the communication system 100 may communicate with other devices using Bluetooth technology.

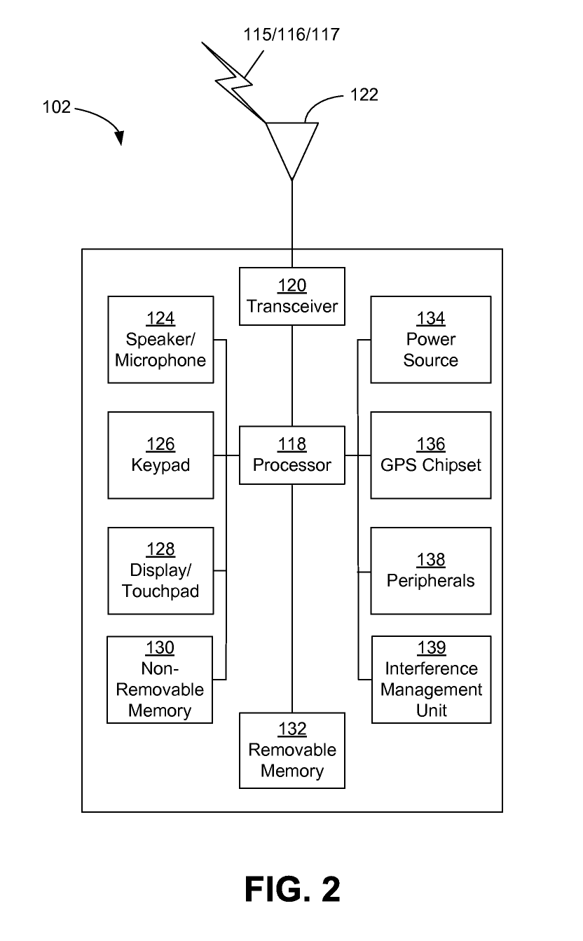

FIG. 2 is a system diagram illustrating an example WTRU 102. As shown in FIG. 2, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Array (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 2 depicts the processor 118 and the transceiver 120 as separate components, it will be appreciated that the processor 118 and the transceiver 120 may be integrated together in an electronic package or chip.

The transmit/receive element 122 may be configured to transmit signals to and/or receive signals from, a base station (e.g., the base station 114a) over the air interface 115/116/117. For example, in one embodiment, the transmit/receive element 122 may be an antenna configured to transmit and/or receive RF signals. In another embodiment, the transmit/receive element 122 may be an emitter/detector configured to transmit and/or receive IR, UV, or visible light signals, for example. In yet another embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 2 as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and/or receiving wireless signals over the air interface 115/116/117.

The transceiver 120 may be configured to modulate the signals that are to be transmitted by the transmit/receive element 122 and/or to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as UTRA and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 115/116/117 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, and the like.

The WTRU 102 may include a full duplex radio for which transmission and reception of some or all of the signals (e.g., associated with particular subframes for both the UL (e.g., for transmission) and downlink (e.g. for reception) may be, for example partially or fully, concurrent and/or simultaneous. The full duplex radio may include an interference management unit 139 to reduce and/or substantially eliminate self-interference via either hardware (e.g., a choke) or signal processing via a processor (e.g., a separate processor (not shown) or via processor 118).

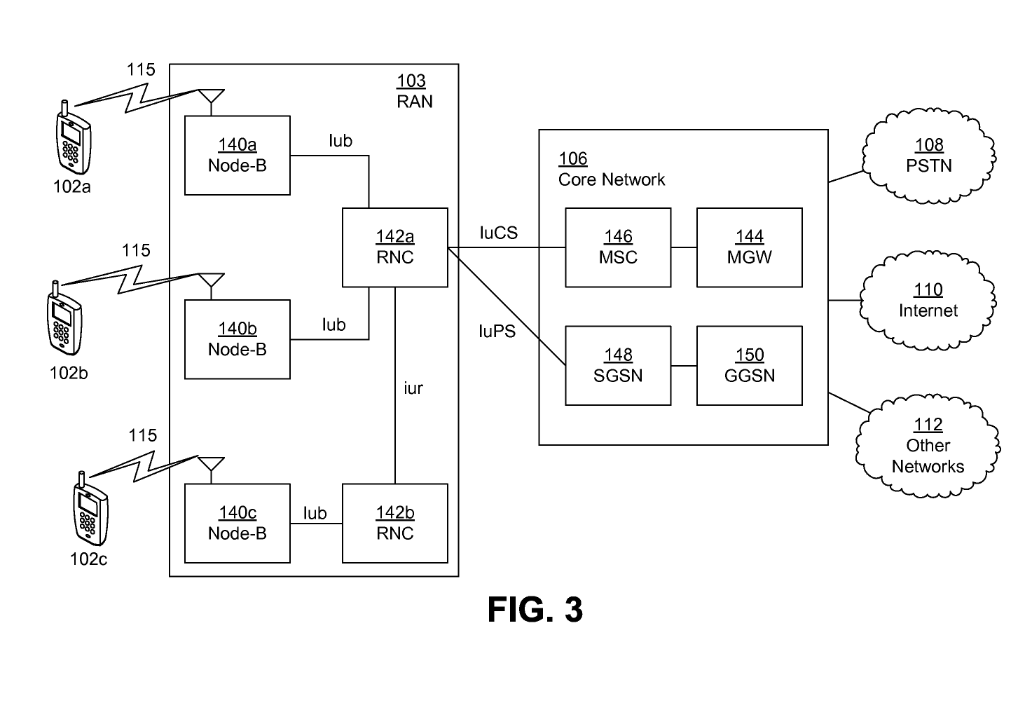

FIG. 3 is a system diagram illustrating the RAN 103 and the core network 106 according to another embodiment. As noted above, the RAN 103 may employ a UTRA radio technology to communicate with the WTRUs 102a, 102b, 102c over the air interface 115. The RAN 103 may also be in communication with the core network 106. As shown in FIG. 3, the RAN 103 may include Node-Bs 140a, 140b, 140c, which may each include one or more transceivers for communicating with the WTRUs 102a, 102b, 102c over the air interface 115. The Node-Bs 140a, 140b, 140c may each be associated with a particular cell (not shown) within the RAN 103. The RAN 103 may also include RNCs 142a, 142b. It will be appreciated that the RAN 103 may include any number of Node-Bs and RNCs while remaining consistent with an embodiment.

As shown in FIG. 3, the Node-Bs 140a, 140b may be in communication with the RNC 142a. Additionally, the Node-B 140c may be in communication with the RNC 142b. The Node-Bs 140a, 140b, 140c may communicate with the respective RNCs 142a, 142b via an Iub interface. The RNCs 142a, 142b may be in communication with one another via an Iur interface. Each of the RNCs 142a, 142b may be configured to control the respective Node-Bs 140a, 140b, 140c to which it is connected. In addition, each of the RNCs 142a, 142b may be configured to carry out or support other functionality, such as outer loop power control, load control, admission control, packet scheduling, handover control, macrodiversity, security functions, data encryption, and the like.

The core network 106 shown in FIG. 3 may include a media gateway (MGW) 144, a mobile switching center (MSC) 146, a serving GPRS support node (SGSN) 148, and/or a gateway GPRS support node (GGSN) 150. While each of the foregoing elements are depicted as part of the core network 106, it will be appreciated that any one of these elements may be owned and/or operated by an entity other than the core network operator.

The RNC 142a in the RAN 103 may be connected to the MSC 146 in the core network 106 via an IuCS interface. The MSC 146 may be connected to the MGW 144. The MSC 146 and the MGW 144 may provide the WTRUs 102a, 102b, 102c with access to circuit-switched networks, such as the PSTN 108, to facilitate communications between the WTRUs 102a, 102b, 102c and traditional land-line communications devices.

The RNC 142a in the RAN 103 may also be connected to the SGSN 148 in the core network 106 via an IuPS interface. The SGSN 148 may be connected to the GGSN 150. The SGSN 148 and the GGSN 150 may provide the WTRUs 102a, 102b, 102c with access to packet-switched networks, such as the Internet 110, to facilitate communications between and the WTRUs 102a, 102b, 102c and IP-enabled devices.

As noted above, the core network 106 may also be connected to the other networks 112, which may include other wired and/or wireless networks that are owned and/or operated by other service providers.

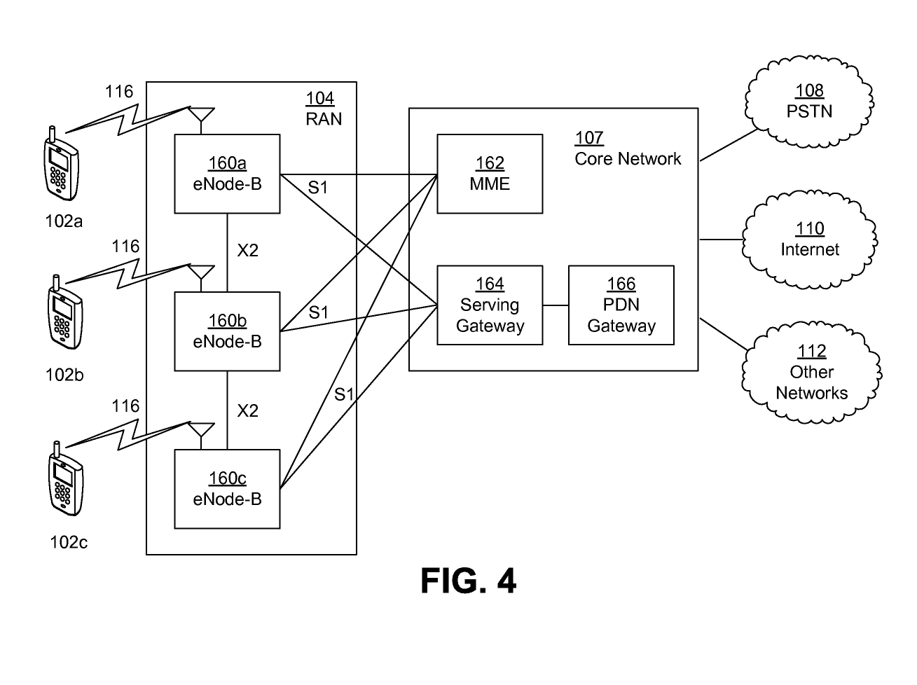

FIG. 4 is a system diagram illustrating the RAN 104 and the core network 107 according to an embodiment. As noted above, the RAN 104 may employ an E-UTRA radio technology to communicate with the WTRUs 102a, 102b, 102c over the air interface 116. The RAN 104 may also be in communication with the core network 107.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In one embodiment, the eNode-Bs 160a, 160b, 160c may implement MIMO technology. Thus, the eNode-B 160a, for example, may use multiple antennas to transmit wireless signals to, and/or receive wireless signals from, the WTRU 102a.

Each of the eNode-Bs 160a, 160b, 160c may be associated with a particular cell (not shown) and may be configured to handle radio resource management decisions, handover decisions, scheduling of users in the UL and/or DL, and the like. As shown in FIG. 4, the eNode-Bs 160a, 160b, 160c may communicate with one another over an X2 interface. The eNode-B may include a full duplex radio similar to that of the UE (e.g., with an interference management unit). The core network 107 shown in FIG. 4 may include a mobility management entity (MME) 162, a serving gateway (SGW) 164, and a packet data network (PDN) gateway (or PGW) 166. While each of the foregoing elements are depicted as part of the core network 107, it will be appreciated that any of these elements may be owned and/or operated by an entity other than the core network operator.

The MME 162 may be connected to each of the eNode-Bs 162a, 162b, 162c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The serving gateway 164 may be connected to each of the eNode-Bs 160a, 160b, 160c in the RAN 104 via the S1 interface. The serving gateway 164 may generally route and forward user data packets to/from the WTRUs 102a, 102b, 102c. The serving gateway 164 may perform other functions, such as anchoring user planes during inter-eNode-B handovers, triggering paging when DL data is available for the WTRUs 102a, 102b, 102c, managing and storing contexts of the WTRUs 102a, 102b, 102c, and the like.

The serving gateway 164 may be connected to the PDN gateway 166, which may provide the WTRUs 102a, 102b, 102c with access to packet-switched networks, such as the Internet 110, to facilitate communications between the WTRUs 102a, 102b, 102c and IP-enabled devices.

The core network 107 may facilitate communications with other networks. For example, the core network 107 may provide the WTRUs 102a, 102b, 102c with access to circuit-switched networks, such as the PSTN 108, to facilitate communications between the WTRUs 102a, 102b, 102c and traditional land-line communications devices. For example, the core network 107 may include, or may communicate with, an IP gateway (e.g., an IP multimedia subsystem (IMS) server) that serves as an interface between the core network 107 and the PSTN 108. In addition, the core network 107 may provide the WTRUs 102a, 102b, 102c with access to the other networks 112, which may include other wired and/or wireless networks that are owned and/or operated by other service providers.

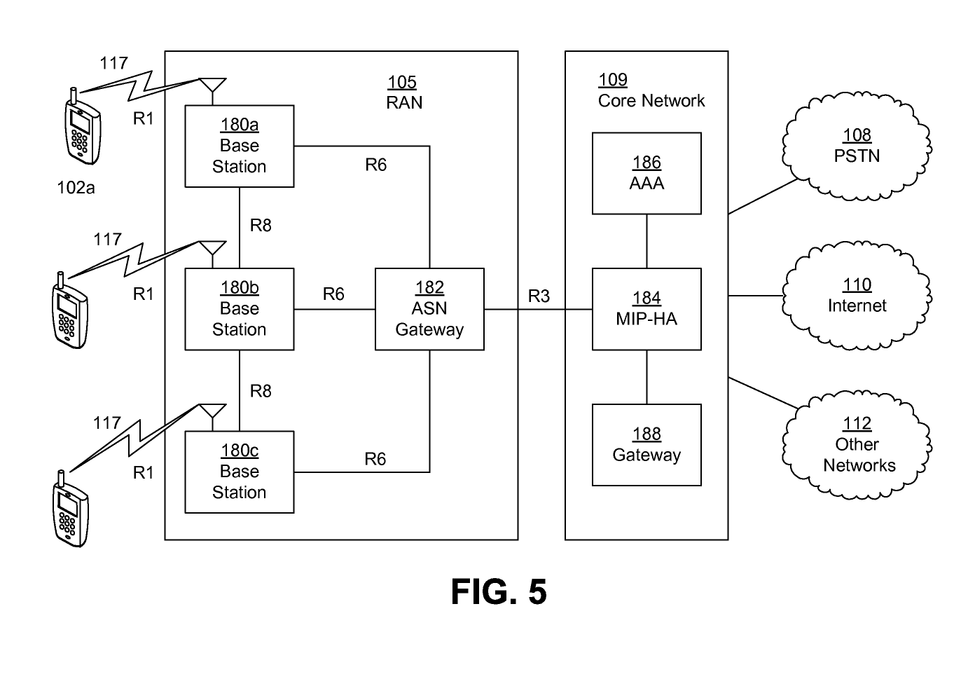

FIG. 5 is a system diagram illustrating the RAN 105 and the core network 109 according to an embodiment. The RAN 105 may be an access service network (ASN) that employs IEEE 802.16 radio technology to communicate with the WTRUs 102a, 102b, 102c over the air interface 117. As will be further discussed below, the communication links between the different functional entities of the WTRUs 102a, 102b, 102c, the RAN 105, and the core network 109 may be defined as reference points.

As shown in FIG. 5, the RAN 105 may include base stations 180a, 180b, 180c, and an ASN gateway 182, though it will be appreciated that the RAN 105 may include any number of base stations and ASN gateways while remaining consistent with an embodiment. The base stations 180a, 180b, 180c may each be associated with a particular cell (not shown) in the RAN 105 and may each include one or more transceivers for communicating with the WTRUs 102a, 102b, 102c over the air interface 117. In one embodiment, the base stations 180a, 180b, 180c may implement MIMO technology. The base station 180a, for example, may use multiple antennas to transmit wireless signals to, and/or receive wireless signals from, the WTRU 102a. The base stations 180a, 180b, 180c may also provide mobility management functions, such as handoff triggering, tunnel establishment, radio resource management, traffic classification, quality of service (QoS) policy enforcement, and the like. The ASN gateway 182 may serve as a traffic aggregation point and may be responsible for paging, caching of subscriber profiles, routing to the core network 109, and the like.

The air interface 117 between the WTRUs 102a, 102b, 102c and the RAN 105 may be defined as an R1 reference point that implements the IEEE 802.16 specification. In addition, each of the WTRUs 102a, 102b, 102c may establish a logical interface (not shown) with the core network 109. The logical interface between the WTRUs 102a, 102b, 102c and the core network 109 may be defined as an R2 reference point, which may be used for authentication, authorization, IP host configuration management, and/or mobility management.

The communication link between each of the base stations 180a, 180b, 180c may be defined as an R8 reference point that includes protocols for facilitating WTRU handovers and the transfer of data between base stations. The communication link between the base stations 180a, 180b, 180c and the ASN gateway 182 may be defined as an R6 reference point. The R6 reference point may include protocols for facilitating mobility management based on mobility events associated with each of the WTRUs 102a, 102b, 102c.

As shown in FIG. 5, the RAN 105 may be connected to the core network 109. The communication link between the RAN 105 and the core network 109 may be defined as an R3 reference point that includes protocols for facilitating data transfer and mobility management capabilities, for example. The core network 109 may include a mobile IP home agent (MIP-HA) 184, an authentication, authorization, accounting (AAA) server 186, and a gateway 188. While each of the foregoing elements are depicted as part of the core network 109, it will be appreciated that any of these elements may be owned and/or operated by an entity other than the core network operator.

The MIP-HA 184 may be responsible for IP address management, and may enable the WTRUs 102a, 102b, 102c to roam between different ASNs and/or different core networks. The MIP-HA 184 may provide the WTRUs 102a, 102b, 102c with access to packet-switched networks, such as the Internet 110, to facilitate communications between the WTRUs 102a, 102b, 102c and IP-enabled devices. The AAA server 186 may be responsible for user authentication and for supporting user services. The gateway 188 may facilitate interworking with other networks. For example, the gateway 188 may provide the WTRUs 102a, 102b, 102c with access to circuit-switched networks, such as the PSTN 108, to facilitate communications between the WTRUs 102a, 102b, 102c and traditional land-line communications devices. The gateway 188 may provide the WTRUs 102a, 102b, 102c with access to the other networks 112, which may include other wired and/or wireless networks that are owned and/or operated by other service providers.

Although not shown in FIG. 5, it will be appreciated that the RAN 105 may be connected to other ASNs, other RANs (e.g., RANs 103 and/or 104) and/or the core network 109 may be connected to other core networks (e.g., core network 106 and/or 107. The communication link between the RAN 105 and the other ASNs may be defined as an R4 reference point, which may include protocols for coordinating the mobility of the WTRUs 102a, 102b, 102c between the RAN 105 and the other ASNs. The communication link between the core network 109 and the other core networks may be defined as an R5 reference, which may include protocols for facilitating interworking between home core networks and visited core networks.

Although the WTRU is described in FIGS. 1-5 as a wireless terminal, it is contemplated that, in certain representative embodiments, such a terminal may use (e.g., temporarily or permanently) wired communication interfaces with the communication network.

### II. REPRESENTATIVE SOCIAL NETWORKING APPLICATIONS

Representative mechanisms for friend grouping, friend find, and/or proximity discovery may be applied to social networking applications (e.g., for exchange of information between or among social networking applications) and/or in other application areas such as gaming, machine-to-machine communications, vehicular communications, public safety and/or commercial advertisement, among others.

Although various embodiments are shown and described with respect to social networking applications, it is contemplated that the procedures and mechanisms set forth herein may be applied to gaming, machine-to-machine communications, vehicular communications, public safety and/or commercial advertisement, among others to group and/or match users and/or FOIs, and to provide proximity discovery and/or tracking of the groups or matched users or FOIs between or among the various applications.

In the context of social networking applications, a “Friend” may be deemed to be any person or entity defined, for example, as a friend by the user of the application. As set forth herein, such a person or an entity may be referred to as a FOI. A user may want or desire to discover whether a FOI with a UE is in proximity with the user for any of a number of reasons. For instance, the user may wish to exchange information with a FOI and/or track the FOI's location. A social networking application that may be used with representative embodiments may generally be referred to herein as an Application in Use (AIU).

The identities and personal information of a FOI, which is typically referred to as a user profile of the FOI, may be included in a repository accessible by a single application (e.g., the AIU). The repository (e.g., a table, a flat file, a list, and/or a database) may be a part of and/or managed by the AIU. Alternately, the repository may belong to a third party application that may allow use of its information.

A FOI may be defined directly by the user (e.g., by tagging the name of the FOI) and/or indirectly by one or more attributes of the FOI. Some examples of attributes that may be used to define a person as an FOI may include, for example: (1) one or more keywords; (2) an expressed interest in a certain topic; (3) personal photos of the FOI; (4) a history of the FOI; (5) places visited by the FOI, (6) websites visited by the FOI; (7) a current location of the FOI; (8) a context of the FOI; and/or (9) a status of the FOI. In some representative embodiments, users (e.g., all users) of a certain application may be deemed FOIs (i.e., implicitly considered a FOI).

A person or user may have one or more reasons for finding and/or defining a FOI, for example: (1) to exchange information (e.g., chat, video chat, text) with the FOI; (2) to locate and/or discover the FOI; and/or (3) to location track (e.g., for family members) the FOI, (e.g., which may include proximity discovery, for example, when the FOI is within logical or physical proximity for further information exchanges). Direct proximity may generally be referred to or defined as a condition wherein the user and the FOI are (depending on the purpose of the FOI) sufficiently close for direct communication and/or direct interaction between or among the user and the FOI.

Incentives may exist for application providers to maintain certain information about its users, including, for example, the identity of the user, attributes of the user, and/or shopping habits of the user, which may be collected or tracked via the application (e.g., AIU). The usefulness of many social networking applications depends to a significant extent on having a large a number of users (along with the aforementioned collected user information of those users). However, social networking application providers frequently are reluctant to share such collected user information with other social networking application providers (e.g., because of the commercial advantages of having knowledge of such information). Hence, start-up applications with a small set of users may find it difficult to attract new users, as new users may not be able to find FOI using the start-up application.

Many social networking applications use location services for any number of reasons, including, but not limited to proximity detection. Certain geographical location estimates use GPS with periodic reporting through the application to an application server. The use of periodic GPS may shorten battery life, which may limit the usefulness of proximity discovery. Other location estimation processes (for example, WiFi Positioning System (WPS) cellular triangulation techniques, and/or cell identification) may provide a geographical location of a device, may enable indoor coverage and/or provide for longer battery life, and also may be used for providing proximity services.

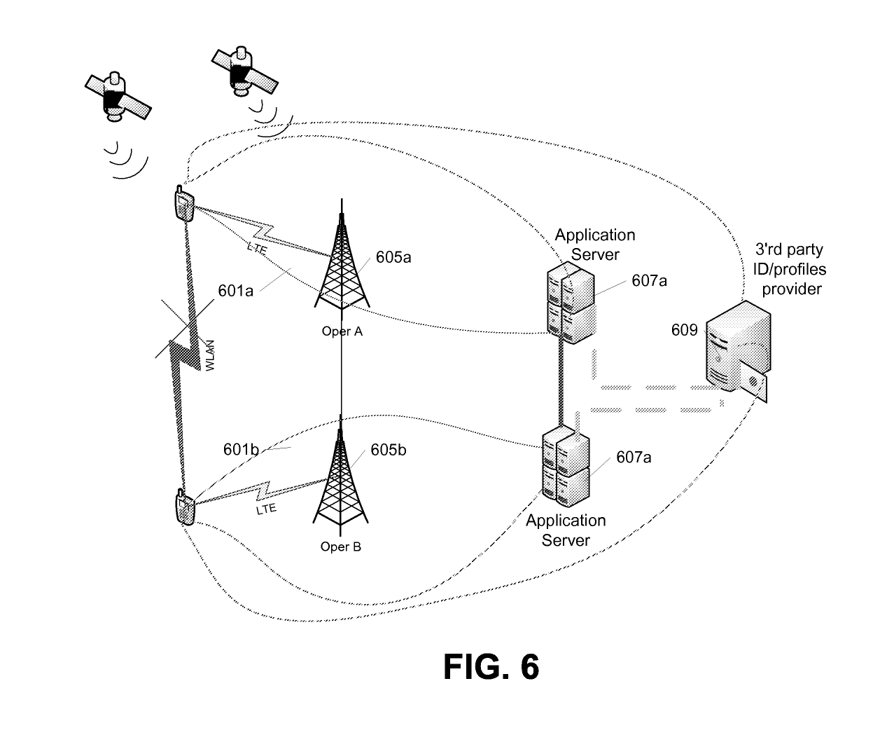

FIG. 6 is a diagram illustrating a representative architecture for applications that may provide proximity notifications. In FIG. 6, a first UE 601a may communicate via a first Mobile Network (MN) 605a with a first application server 607a (e.g., AIU) and a second UE 601b may communicate via a second MN 605b with a second application server 607b. The user of the first UE 601a and the user of the second UE 601b may have been previously grouped and identified as friends of interest via a third party provider 609. When the first and second UEs are in direct proximity, each application may alert its user of this condition in order to facilitate direct UE to UE communication, information exchange via the UEs, and/or a meeting of the two users.

In certain representative embodiments, representative mechanisms (e.g., Converged Address Book (CAB)) and/or formats may be used to define categorized attributes which, in turn, may be used to describe, for example, people and/or a query/response system to transfer information between applications. Thus, CAB is a data base access scheme that allows the return of certain characteristics of users in a standardized manner. However, it does not allow the controlled information exchange, such as is described in the present specification (see http://technical.openmobilealliance.org/Technical/technical-information/release-program/current-releases/cab-v1-Ohttp://technical.openmobilealliance.org/Technical/technical-information/release-program/current-releases/cab-v1-0).

Thus, there are several potential obstacles to the use and acceptance of some (e.g., start up) social networking and other applications as well as the use of proximity services by users. One obstacle is the splintered market of social networking applications. For example, in general, acceptance and use of a social networking application and/or proximity services by users may be highly dependent on users' perception that most (or at least enough) people of interest to that user have access to each other through the application or proximity service. In reality, the population of users is splintered across multiple social networking (or other) applications as well as across multiple mobile networks, not necessarily all of whom may offer proximity services such as ProSe.

Another potential issue with existing technologies is difficulty in sharing user information across different social networking applications, e.g., for purposes of identifying and finding FOIs among others.

Also, many application providers rely on a paid third party application to collect and maintain user information, in essence becoming a user interface to the information in the third party application, which may be undesirable for the application providers.

### III. OVERVIEW

In the exemplary use cases above, users of the mechanisms may require the true (e.g., as defined by the application) identity of a FOI. In other use cases, true identity may not be of interest. For example, one may search a pharmaceutical data base for drug interactions and find profiles of patients who have experienced such. Then, the patient medical history may be highly relevant, but there may be no need to know the patient's name or identity.

Another notion is that of reciprocity of information. In some cases, both sides may want to learn each other's true identity and, moreover, may wish to disclose their own identities if and only if the other person also discloses his/her identity. In other cases, such reciprocity may not be required (for example searching a data base of resumes for potential hiring typically would not involve the searchee requiring the searcher to disclose his/her/its identity).

The procedures exemplified below support all these use cases (and many more) and can be effected by appropriate selection of the disclosed attributes and/or information elements placed in the messages that are exchanged between the applications and/or the broker.

In accordance with certain representative embodiments, a Broker may facilitate the identification and/or locating of FOIs across different applications and/or different MN operators. The broker may enable proximity services regardless of logical (e.g., same network) and/or geographic proximity.

In certain representative embodiments, the Broker may enable sharing of user information (anonymized or not) across multiple applications and/or operators to allow proximity services and FOI identification.

As previously noted, GPS may cause unacceptable battery drain and may limit the time for proximity services and/or friend discovery. In certain representative embodiments, representative procedures may be implemented to reduce and/or eliminate dependency on GPS to significantly improve battery life and user experience.

In certain representative embodiments, procedures for inter-PLMN ProSe discovery (e.g., for example via 3GPP) may be implemented. In certain representative embodiments, ProSe may use location pre-filtering (e.g., using idle mode location tracking procedures) and may use less direct over the air sensing or GPS usage. The 3GPP-supported case that is employed in certain embodiments described herein in the present specification is already a part of ProSe. The present specification also describes a non-3GPP based mechanism.

In certain representative embodiments, procedures may be implemented to enable ProSe for inter-application operation.

In certain representative embodiments, procedures may be implemented to enable FOI finding across different applications provided by different providers with or without the applications sharing some or most of the user information (e.g., by anonymizing the information and/or sharing the information in stages).

In certain representative embodiments, representative mechanisms and/or procedures may be implemented to enable inter-PLMN FOI discovery and communications.

In certain representative embodiments, representative mechanisms and/or procedures may be implemented to enable search for “friends” or FOI by name or handles and/or by context, keywords, properties, characteristics, and/or attributes.

In certain representative embodiments, representative mechanisms and/or procedures may be implemented to enable user information residing in an application to not leave the application (e.g., sent to another application) except as directed by the user via user input to the respective UE and/or authorized by the application provider.

In certain representative embodiments, representative mechanisms and/or procedures may be implemented to enable two applications to exchange information through a “Broker”.

In certain representative embodiments, representative mechanisms and/or procedures may be implemented to enable user information to not be provided to operators or third party entities that enable user information sharing mechanisms (e.g., a Broker used for sharing information).

In certain representative embodiments, representative mechanisms and/or procedures may be implemented to enable users to maintain control of their identity and the user profiles and/or characteristics throughout any grouping, proximity, and/or matching processes.

In certain representative embodiments, representative mechanisms and/or procedures may be implemented to enable user information sharing with minimal and/or no UE/WTRU modifications.

In certain representative embodiments, representative mechanisms and/or procedures may be implemented to minimize or eliminate the use of GPS and battery-heavy geolocation techniques through use of cell identity, for example, if and/or where available.

A. Representative Use Case

Three students (e.g., Alice, Bob, and Charlie) may be touring the historic city of Jerusalem (e.g., where there are many sites of religious, historical, and/or artistic interest). None of the students knows each other. Alice, Bob, and Charlie may each have a communication device (e.g. a UE and/or WTRU, which may enable group formation and/or they may be part of a pre-existing group (e.g., Group A). Alice, Bob and Charlie may each subscribe to an operator that may allow them to communicate with third party applications. One or more of the communication devices may communicate with other devices (e.g., of users in the group) via the operator's network (e.g., the cellular network) and/or via other networks (e.g., by WLAN, by corporate LAN, by a university network, by a wired network and/or by a WiFi network, among others). Alice and Charlie may subscribe to operator A (OpA) and Bob may subscribe to operator B (OpB). One of more of the operators (e.g., OpA and/or OpB) may deploy 3GPP ProSe and may use one or more representative procedures and/or mechanisms.

Alice and Charlie may use a first social networking application (e.g., AppA), for example, provided by one university. Bob may use a second social networking application (e.g., AppB) provided by another university. Their respective profiles and/or personal information (e.g., user profiles) may be managed by their respective applications (e.g., AppA for Alice and Charlie and AppB for Bob).

A representative mechanism and/or procedure may be used, which may allow participants to determine the existence of other participants of potential interest to them (e.g., FOIs) and learn some information about those participants. Some or all of the participants may control if and/or when information about themselves is shared with other participants. The procedure, at this stage, may or may not to lead to proximity discovery and/or may be independent of the use of 3GPP type ProSe.

Alice, Bob, and Charlie may wish to tour the city in the company of other people, for example, one or more people who share their interests. Alice, Bob, and Charlie may interact with their respective social networking applications indicating they may like to find someone to tour with. Alice, Bob, and Charlie each may indicate his/her own interests and/or relevant attributes (e.g. age, area of interest, items of interest, and/or the historical periods they are interested in). Alice, Bob, and Charlie also may each specify the attributes of those they would like to interact with (e.g., which may not be the same as their own attributes). The interaction may take place using any device or communication system including wired or wireless devices (e.g., through their mobile devices and/or UEs).

In certain representative embodiments, the social applications interact with each other, directly or indirectly (e.g., via a Broker), to find a FOI, e.g., a user that matches certain criteria (e.g., having a specified set of one or more attributes). A third party identity assertion service may be used to facilitate or enable the matching process.

Some or all users may be requested to authorize information exchange before it will be allowed to occur. If a user does not authorize such an exchange, the process may terminate with regard to that user. If at least two of the users authorize information exchange, a “grouping” may be created of two or more users.

Any two or more of a larger set of users (e.g., Alice, Bob, and Charlie) may be made aware of each other (either using actual or anonymized identities) and/or one another's general interests. As disclosed herein, an “identity” may be as defined by an application (e.g., a username, a handle, and/or other user related identifier). For example, the username may or may not be equivalent to a person's legal name and/or address, depending on the application.

Proximity discovery may be set up so that users may be notified, if and/or when one or more members of a group of users (e.g., Group A) are in proximity. Although group formation is illustrate as described above, it is contemplated that other groups may be formed using other mechanisms and/or procedures. For example, users may create a group in a single application, such as in Facebook, Linked-in, or other social media applications, and may use representative proximity discovery procedures set forth herein.

Alice and Bob may indicate to their respective application servers that they would like to be discoverable by others when they are in proximity to them. Each may use the application on his/her respective WTRU to identify (to his/her application server the WTRU that he/she is using.

Charlie may be interested in joining with Alice and Bob and may indicate the desire to join Alice and/or Bob to his application. Alice and/or Bob may or may not be interested in being discovered by Charlie and/or Alice and/or Bob may or may not be interested in discovering Charlie. Alice and/or Bob may also specify some parameters (e.g., ProSe parameters) such as discovery range, and/or other conditions, among others.

A server may be aware of the identities of those interested in being discovered by each other (for example, via a grouping database (not shown). The server may be specified (e.g., by 3GPP) and/or may belong to an operators' network.

B. Representative Non-3GPP Proximity Detection Procedures

The server may interact with the respective WTRUs of Alice and Bob to determine their relative positions (e.g., relative geolocations). If the server determines that the WTRUs of Alice and Bob are in proximity and/or likely to be in proximity (e.g. at the range defined by the users), the server may generate proximity parameters, for example, including identities to be used over the air and/or used for their mutual discovery by a radio network (e.g., radio access means, such as a wireless network. The WTRUs of Alice and/or Bob may attempt to detect each other using the chosen radio access. If Alice and/or Bob do not desire to be discovered by Charlie, information to determine the proximity of Bob and/or Alice may not be provided to Charlie.

The respective applications used by Alice and Bob may be notified of successful discovery. The users may be notified by their respective applications of a successful discovery. Alice and Bob may choose to meet in person or share information, via their respective applications, of the places one or both are visiting.

C. Representative 3GPP-based Proximity Detection Procedures

The server may interact with the mobile network operator (MNO) entity responsible for ProSe (e.g., a ProSe Server or any other entity with similar functionality). If the server determines that the users (e.g., Alice and Bob) are in proximity and/or likely to be in proximity), the server may generate the proximity parameters including, for example, the identities to be used over the air and/or used or required for their mutual discovery by either LTE or other air interfaces (e.g., a WLAN interface). The WTRUs of Alice and/or Bob may attempt to detect each other using the chosen radio access. If Alice and/or Bob do not desire to be discovered by Charlie, information to determine the proximity of Bob and/or Alice may not be provided to Charlie.

The respective applications used by Alice and Bob (e.g., the user interfaces of Alice and Bob) may be notified of success, and Alice and Bob, after such notification, may choose to meet in person and/or share information (e.g., of the places one or both are visiting) via their respective applications.

### IV. IMPLEMENTATIONAL DETAILS

Procedures may be implemented to enable discovery of FOIs across multiple applications (such as social networking applications) and multiple networks (such as mobile networks) as well as proximity services. At least some of the embodiments described below utilize a third party server to perform some of the processes. However, it will be understood that the server alternately may be a MN operator-owned server (e.g., an EPC ProSe server).

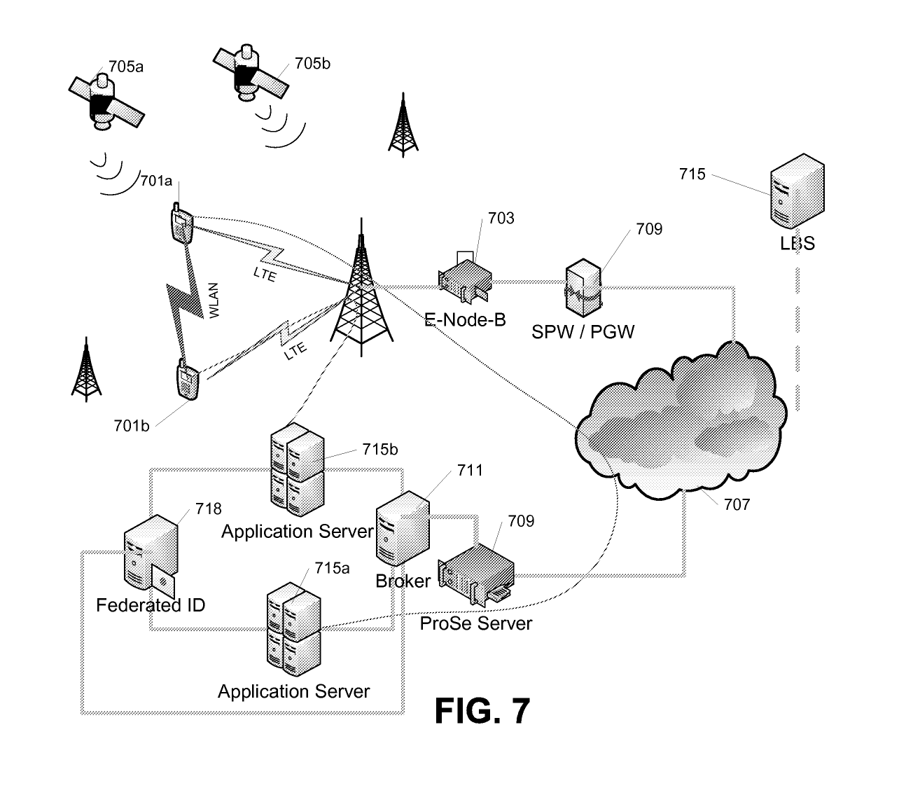

An exemplary architecture is depicted in FIG. 7. This architecture shown attempts to encompass most of the embodiments discussed herein. Hence, in certain embodiments, less than all of the components may be used. Merely as an example, in embodiments that do not use a Broker, i.e., the application servers of the different social networking sites communicate with each other directly, then the Broker node would not be used. In other embodiments that do not take advantage of GPS, then the GPS satellites would not be used, etc.

WTRUs 701a and 701b communicate with an eNB 703. Of course, the WTRUs may be connected to different eNBs and, in fact may be on completely different mobile networks. However, in order not to obfuscate the diagram, they are shown as connected to the same eNB 703 in this exemplary embodiment. The WTURs 701a and 701b also may derive GPS signals for purposes of geolocation via one or more GPS satellites 705a, 705b. The eNB can transfer communications between the WTRUs and nodes of a network (such as the Internet 707) through an evolved packet core (not expressly shown) including a Serving Gateway (SGW) and/or Packet Gateway (PGW) 709. Some of those nodes include a Broker 711, a ProSe server 713 (or other proximity type server), a Location Based Service server 715, the applications servers 715a, 715b of the social networking applications that they respectively use. In this example, the user of WTRU 701a uses a first application (e.g., Facebook) serviced by application server 715a and the user of WTRU 701b uses a second application (e.g., Myspace) serviced by application server 715b. In some cases, one or more of the application providers (i.e., the owners/operators of applications servers 715a, 715b) may rely on a paid third party application to collect and maintain user information in an independent ID server 718.

A first set of representative procedures may implement a process of grouping application users as herein described and at the end of which two or more users may realize that they are of interest to each other based on attributes (e.g., attributes and/or information shared between or among the users). A second set of procedures may then implement a process by which these users may learn of one another's proximity. In certain representative embodiments, these procedures may have differences in their level of security and/or user interaction. For example, the amount of security may be used to tailor the procedure to the security requirements of the applications involved. As one example, the user identity itself (e.g., as defined by an application) may be hidden from the other application by using a temporary identifier (ID), which may allow a level of anonymization of the information/attributes of the user that are exchanged. When using the temporary ID, users' attributes/information can be shared, while the actual identities of the users are not shared. As another example, some or all of the attributes in a user profile may not be shared while other, shared attributes/information may be used for a match between or among the users. In yet other embodiment, the attributes that are shared (i.e., used to determine matches) may be anonymized such that the server can perform the task of matching users to each other, but does not know the actual true attributes. The anonymization of some or all of the attributes may be implemented using a hash key to hash the user profile or any portion(s) of the user profile with a one-way function and can hide the actual data from the server and/or the other user. Then, if the users (and/or the applications or application operators) agree after the initial match to allow sharing of the user profile, the key may be shared by each user/application with the other applications to enable a determination of the hashed user profile or the hashed portions of the user profile.

As an example, if User A wishes to look for a FOI with a match of his hobbies, then, under the category “hobbies”, User A may indicate “Tennis” and “Squash”. These terms may be hashed individually or in groups. The hashed attributes may be compared to hashed attributes in user B's profile without the server (e.g., a Broker) knowing what the terms stand for. The category “hobbies” itself may also be hashed and may allow the information to be hidden from a third party server used as a Broker for the information exchange. AppA and AppB may negotiate a hashing function between themselves. The hashing function, which may not be reversed by the Broker, may be used in the matching process. AppA and AppB may send the hashed information to the Broker with random user IDs such that the Broker may determine whether attributes match without knowing either what the actual attributes are or the users' permanent identities. A phishing scheme may attempt to mine a database to determine users' attributes by a systematic search involving multiple queries (e.g., using “bogus” user records). Various aspects of the embodiments disclosed herein, however, can be used to eliminate or minimize the effectiveness of such phishing schemes, including, but not limited to requiring payment for queries, anonymization of users until payment is received, etc. Furthermore, such phishing expeditions would leave a record (e.g., at the Broker) that can be used for detecting and blocking future phishing expeditions by such users.

At an appropriate juncture, the users may be asked for permission (e.g., explicit or default, for example, based on predetermined conditions) to share information (e.g., personal information, attributes and/or user identifiers) with another user determined to be a match. The type of information that may be shared at each stage may vary by procedure. For example, a user's permanent identity or other personal information may, if desired, only be shared upon explicit mutual permission granted by the user. Alternately, it may be implied that a first user has agreed to share his or her identity with a second user when the first user asks for the true identity of the other user and the other user consents. In certain representative embodiments, the Broker or other third party may provide additional certifications regarding the other matched user prior to or with the personal information exchange. For example, the Broker may maintain a rating system for users (e.g., a database of ratings/complaints regarding users and may provide the score (e.g., rating/complaint score) or actual ancillary information collected about the user (e.g., complaint information) prior to or with the personal information that is for exchange.

There are many ways to define desired attributes for the matching procedures. Merely as a few examples, attributes/information may be categorized; for example, “running” and “cycling” may be categorized as “sports activities”. A given attribute, e.g., football, may be categorized under multiple categories, for example “football” may come under “sports activities” (e.g., to refer to an interest in playing football) or under “interests” (e.g., to refer to an interest in watching football games). Attributes may be defined in either positive or negative terms (e.g., non-smoker or smoker), among others.

### A. Representative Grouping Procedures Directly Between Applications (without a Broker)

In certain representative procedures, applications may exchange messages (e.g., directly between the applications) to find users with, for example, common interests based on their attributes and/or information (e.g., personal information, interests, and/or desires). Many applications operate under a client-server model and run concurrently on both a server and the mobile. In this context, the term “application” will usually refer to the application itself that provides an application service, e.g., via the web, as opposed to a copy of application software that is running on an individual subscriber's device. In fact, many of the procedures described in this text do not require a mobile connection and can be used with the server only via any web interface. Hence, the “application”, e.g., Facebook, may sometimes be referred to as the “application server” herein (e.g., 715a, 715b in FIG. 7), while the copy of the application software that resides on an individual subscriber's device (e.g., WTRU 701a or 701b) may sometimes be referred to as the “application interface software”. It will be understood that these terms are used in a non-limiting way to distinguish between the two. The application server may actually be a server farm, a plurality of server farms, a website, or any other means of providing a service via a network. Likewise, the application interface software may comprise much more than simply an interface to the application server.

The grouping procedures may be performed as a standalone process or may be a precursor to a proximity determination. A third party identity assertion service 718 (e.g., using OpenID) may be accessible to both applications 715a, 715b or the applications may provide their own user identity (which may be an anonymized user identity).

The representative procedures may involve a series of query and responses and may involve a decision by the users of the applications to release information. For example, each user may release initial information and/or attributes and may decide whether to continue the matching procedure based on the released information and/or attributes of the other user. Either user may terminate the process, for example, if, based on the information and/or attributes received, the other user is not of interest to the particular user receiving the information and/or attributes.

Although most of the representative embodiments are shown with two users interacting, this is merely exemplary and any number of users may be included in any of the representative procedures discussed herein.

A user profile may be a set of attributes (e.g., information) which describe the user and may include a “handle”, interests, photos, level of play of certain games, and/or location information, among others. In some embodiments, attributes may not be encrypted so as to allow the application of the other user to properly read/interpret the information. In other embodiments, the other application may be supplied with a decryption key and the information may be encrypted.

1. Example Procedures for Grouping with Anonymized Identities

In certain example procedures, the procedures may progress in incremental (e.g., small, trust building) steps where information may be released in increments by one and/or both sides. A plurality of steps may be used and may include more steps than necessary for the sharing of the information. Other representative procedures may be implemented with fewer steps at the expense of security and/or trust. If User A works with application AppA and User B works with application AppB, in a first step, User A may initiate the grouping process by controlling the application interface software on his device, e.g., WTRU 701a, authorizing the AppA server 715a to send a query to the AppB server 715b. The query may be essentially a request for other users' profiles. Thus, the query may include profile information and/or attributes of User A. The query also may include the sought after profile information and/or attributes of another user. More specifically, in this query, the AppA server 715a may send the following items: (1) a profile format that may identify the format used to convey user profile information; (2) security parameters, which may include confidentiality and/or integrity protection; (3) a message ID, which may be used to identify the message and may include an application ID (for example, the message ID may be derived from a third party identity provided by an identity assertion service); (4) an anonymized identity of User A (for example, if an application ID is not used, the ID may be a globally unique temporary identity (GUTI) and, if an application ID is used, it may be sufficient that the application ID is unique within its application (in certain representative embodiments, if this parameter is omitted, the message ID may be meant to be used as a temporary user ID)); (5) a requested profile which may describe the sought after attributes of a person of interest (sometime referred to as A-Req-Prof.; (6) the requesting user's profile and/or attributes (sometimes referred to as Own profile) which may describe attributes of the querying user (also sometimes referred to as A-Own-Prof) (it is contemplated that the Requested and/or Own profiles may be sent and, if either is omitted, the other alone may be used to find a match); (7) a threshold for declaring a match; and/or (8) weights for attributes used to determine a matching threshold, among others.

In certain embodiments: (1) a single request that has not resulted in a match may result in little or no information being shared; and/or (2) the matching mechanism may be immune to multiple queries (i.e., may not accept or otherwise participate in multiple match attempts from a single source (or even multiple sources) within a certain time period of each other. This can provide a layer of protection against phishing or other malicious or at least undesired commercial or fraudulent schemes. Even if not immune, the representative procedures may provide an increased level of protection of the information as the number of attempts to match received within a certain time period increase.

When the AppB server 715b receives the query, AppB server 715b may perform a comparison procedure to determine if there is a sufficient match between its users (as a match is defined by the query, which may include, not only the attributes to be matched, but also a required level of similarity to declare a match). For instance, this may include comparing A-Req-Prof (the desired attributes specified in the query by user A) against B-Own-Prof (the corresponding attributes of user B) and/or comparing A-Own-Prof (user A's own attributes, e.g., instead of defining a set of desired attributes, user A is simply generically seeking someone like me) against B-Req-Prof (a set of attributes of interest defined by user B). Depending on which profiles are provided, the match may prioritize comparing the requested profiles to the own profiles over those of own profiles to own profiles. It also is possible to compare A-Own-Prof with B-Own-Prof or to compare A-Req-Prof with B-Req-Prof for purposes of finding matches. Sending ones “own profile” is not necessary for all use cases, such as some of the use cases described hereinabove where mutual exchange of identities is not required, e.g., the aforementioned resume searching scenario.

In certain embodiments, a user may define a degree of matching to be applied. Alternately, a default level of matching may be defined by the application. For instance, it may be acceptable that not all attributes match, but rather that only enough of them match or that high priority ones match. The match criterion may include attribute specific weights. If attribute specific weights are not provided, it may be assumed that a perfect match is desired. Alternately, all attributes may be given equal weight. If both users have specified a match criterion, then both criteria may be used and may have to be met.

For example, the requesting application server may desire to match attributes A, B, and C with corresponding weight factors a, b, c, respectively (and this information may be embedded within the query). If A′ denotes the match result for A, B′ denotes the match result for B, and C′ denotes the match result for C, (1) A′=1 when there is a match and A′=0 otherwise, (2) B′=1 when there is a match and B′=0 otherwise, and (3) C′=1 when there is a match and C′=0 otherwise. The overall score of the match may be represented by Equation (1) as follows:

Overall Score=(aA′+bB′+cC′)/(a+b+c) (1)

It should be understood that the match criteria may be built in such a way that certain parameters require an unconditional match while others do not. For example, there could be an attribute that must be matched in order to declare a match, regardless of how many other attributes are matched. For example, attributes may be split into two sets; a first set that requires a perfect match and a second set that does not require a perfect match. Furthermore, there may be a threshold for the second set (or an overall threshold) requirement to declare a match. If there is a perfect match among the first set of attributes and the score associated with the second set or attributes exceeds the threshold, the AppB server 715b determines that a match has occurred.

If no match is found, AppB server 715b may return a “no match found” indication, including in the message, for example, any of: the original message ID and/or its own application ID. In other embodiments, AppB server 715b may not respond at all if a match is not found.

If a match is found, the AppB server 715b may return a response with any one or more of the following data: (1) the message ID that was in the query to which it is responding (e.g., for identification purposes by AppA); (2) the anonymized identity of user B; (3) the relevant user B profile and/or attribute data (e.g., so that the AppA server 715a may check the matching). The relevant user B profile and/or attribute data may, for instance, comprise B-Req-Prof and/or B-Own-Prof.

Both applications AppA and AppB may now be aware of the identities (e.g., anonymized identities) of each other's users.

For some applications, this type of grouping may or may not be sufficient. For example, in some proximity applications, it may not be useful or necessary for each side to know the others' real application identity (e.g., in gaming). In other cases, the procedure may be followed by an extension by which real identities (e.g., in the context of an application) may be exchanged.

It should be understood that, while embodiments are described above in which the users of the different applications interact with each other through server-side software applications, this is merely exemplary. The principles and embodiments disclosed herein also can be employed in other implementations wherein application software resident on the users' devices interact directly with each other without accessing separate server-side software. The user device's may have access to databases of users of their respective applications. In yet other embodiments, the user devices may not have access to databases of other users, but instead compare only the individual profiles of their respective users to the criteria (e.g., user profile attributes) set forth in grouping queries that they receive.

2. Example Procedure for Extension to Named Grouping

In some cases, an anonymized grouping may not be sufficient. For example, for ProSe discovery of colleagues in an office, the real identities of the discoverer and/or discoveree may be useful and/or required.

In certain representative embodiments, the applications (e.g., both AppA and AppB) may notify their respective users and request permission to share their application-level user identity. An application that received user permission may notify the other application. The notification may be certified in such a way that it cannot be denied. For example, a third party certificate authority may be used for the certification.

An application may send its user identity if its user permits the application to send the user identity. In one exemplary embodiment, the sending is contingent upon receiving an indication from the other application that its user has permitted similar disclosure. In such embodiments, identity sharing (and, by implication, sharing of the attributes that have triggered a match) are guaranteed to be mutual. This feature may, if used properly, prevent phishing attempts. In other embodiments, the user identity may be sent immediately upon receiving user permission, without a guarantee of mutual sharing of information.

### B. Representative Grouping Procedure Between Applications Via a Broker

### 1. Example 1

### Broker Untrusted with Information and Attributes

Depending on the messages and their attributes, in this procedure, a Broker 711 may be used to, e.g., find users with common interests (FOI) between two different applications. Alternately, it may be used to find one or more users with appropriate profiles without implying a requesting user. The Broker functionality may be implemented as a part of the ProSe server 709 described above or may be a separate logical or physical entity, as shown in FIG. 7. All application servers, e.g., 715a, 715b, and the Broker may have access to a trusted third party 718, which may serve as an authorization entity and/or provide keys.

The Broker may act as a third party broker by which one application server may look for information within multiple other application servers without prior arrangements or without knowing the existence of such applications.

The Broker 711 may be trusted to convey messages between application servers, examine confirmations, and/or report to the other side, but is not trusted with user permanent identity, profiles or other personal information.

In one embodiment, the Broker may help provide shared keys to both application servers from a third party without obtaining access to those keys, for example, via a Diffie-Hellman key scheme.

A representative procedure may include User A with WTRU 715a interfacing with AppA server 715a (e.g., Myspace) to request a grouping. User A may specify the other applications with which to attempt to find a grouping, for example, by selecting from a menu provided by the application interface software of appropriate applications provided or presented by AppA or by the Broker. In other embodiments, the Broker may select applications based on its own criteria, which may allow the Broker to keep queried applications anonymous to prevent applications contacting each other directly and bypassing the Broker.

Let us assume that, by whatever mechanism is used, it is determined to look for matches in two applications, AppB (Facebook) and AppC (LinkedIn). The Broker may notify the selected applications (e.g., AppB and AppC) of the grouping attempt. Each application may agree or may be required to agree to the grouping attempt for that application to be included in the remainder of the procedure. The Broker 711 may notify the application AppA 715a of each of the other applications that have indicated willingness to proceed with the attempted grouping.

Although the exemplary procedure is described herein as involving AppA 715a and AppB 715b, it is contemplated that any number of such applications may be involved in the potential grouping.

In general, interactions may be bilateral (e.g., between two parties). It is contemplated that such a bilateral arrangement may produce or imply a star configuration where, e.g., User A may be grouped with User B and/or User C, but User B and User C may not be grouped or may not yet be grouped. The representative procedures may be repeated to achieve multilateral grouping.

A set of keys may be created by which all pairwise application-to-application communications may be carried through the Broker without sharing the information with the Broker. The applications may create or receive the keys using an authentication and a key management entity that may not be part of the Broker. The communications may pass through and be managed by the Broker using a generic bootstrapping architecture (GBA).

Query and response messages similar to those used for the direct interaction procedures may be sent between the AppA server 715a and the AppB server 715b through or via the Broker 711, with the difference that some or all of the attributes in the users' profiles may be key-hashed or otherwise encoded using the keys provided. Thus, the application servers, AppA and AppB, may communicate between themselves without the Broker being privy to the data, information, and/or attributes. On the other hand, message IDs, temporary user identities, and/or consent indications may not be hashed or otherwise encrypted so that they may be known to the Broker and used by the Broker for accounting and/or billing purposes, among others. Users fixed identities, if and when exchanged between the users, may be confidentiality protected between the application servers so that they may remain hidden or obfuscated from the Broker.

If the identities of the applications themselves have been withheld from their counterparts, these identities may be provided to their counterparts after a match has been found or when authorized by the users. Prior to user and/or application identity exchange, the applications may exchange payment credentials. The credentials may be obtained from a third party by the payer and/or may be confirmed by the payee. Either side of the transaction (e.g., User A or User B) may be the payer, and the matter may be negotiated between the applications 715a, 715b through the Broker 711, directly between the users' device 701a, 701b, and/or through another party (e.g., another server).

From the broker point of view, this exemplary process may be described as follows. The Broker 711 receives an attribute match request from an application, e.g., AppA server 715a. The request may contain or include a list of possible target applications to search within. The Broker may use its own information of suitable applications in addition to, in lieu of, or in the absence of the list sent from application A.

The Broker may notify the target applications (e.g. applications B and C) of the request, which may agree or may be required to agree to the matching attempt. The Broker may notify AppA of the other applications that have agreed to the matching attempt or at least that one or more other applications have agreed to participate in the matching attempt. Applications may or may not be required and/or permitted to approve each other prior to proceeding.

If the Broker expects payment for its services and at least one other application (e.g., Application B) has agreed to continue the interaction, the Broker may negotiate at this point with application A (and/or application B) for payment to itself for processing the query. Applications A and B may communicate through the Broker using a common key provided or generated by an authorization and identity management entity (e.g., that is not a part of the Broker). The Broker may or may not be privy to the common key.

At this point, Application A may send a matching query to application B. If the applications A and B are aware of each other's identity, communication may proceed directly between them. In other embodiments, the Broker may control the process by having communications (e.g., all communications) sent through the Broker. The Broker may be aware of the sender's identity and the receiver's identity, but may not be aware of the contents of the message sent between the sender and the receiver.

Application names, if previously withheld, may be provided at this point and applications may exchange payment information between themselves, using the Broker, or using a third party.

a. Exemplary Signal Flow for an Untrusted Broker Embodiment

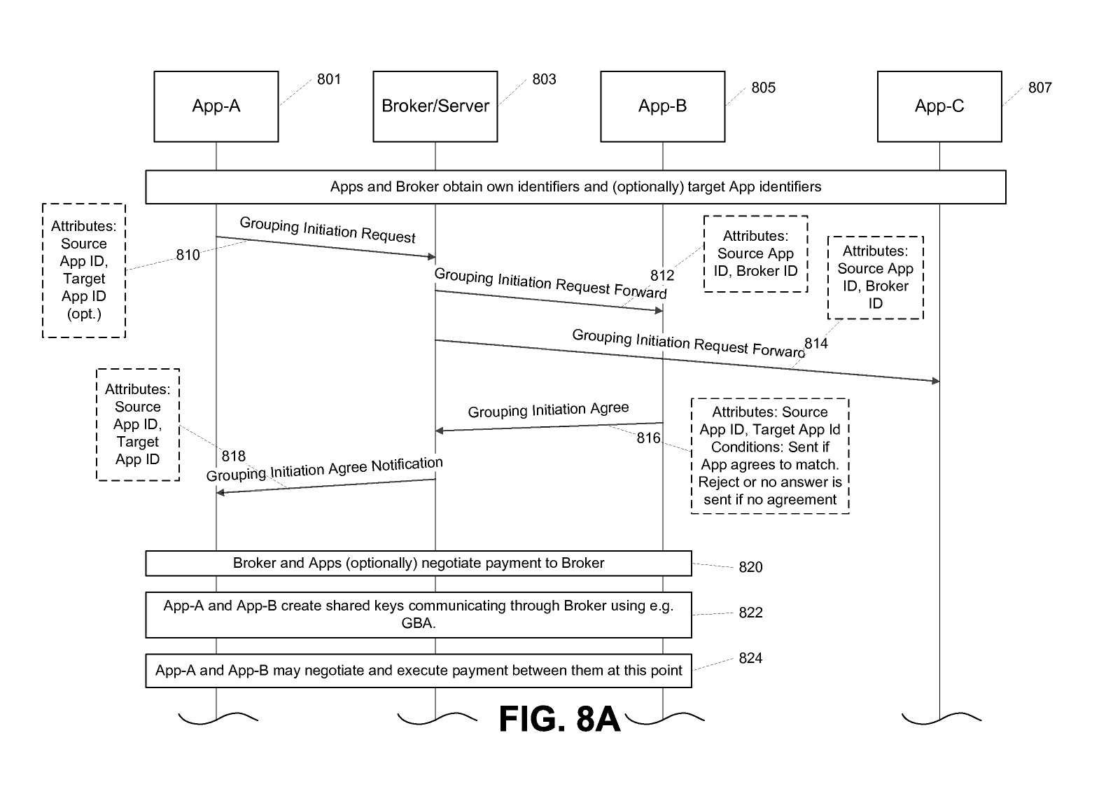

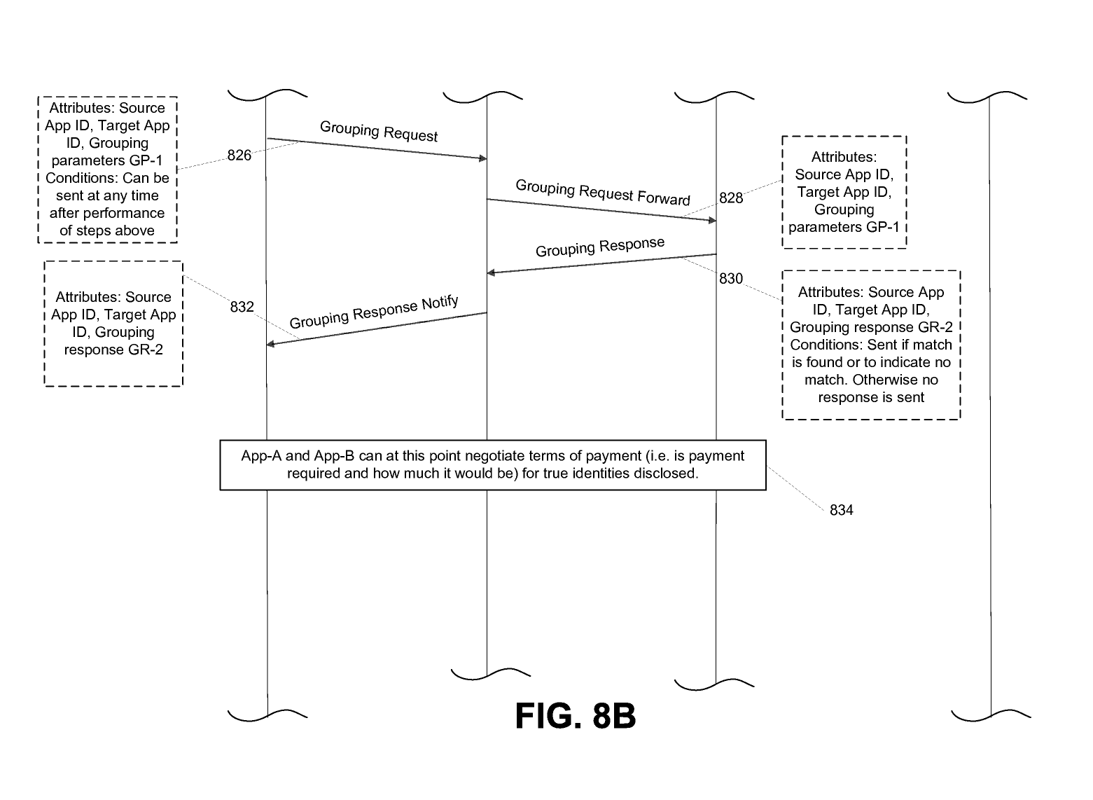

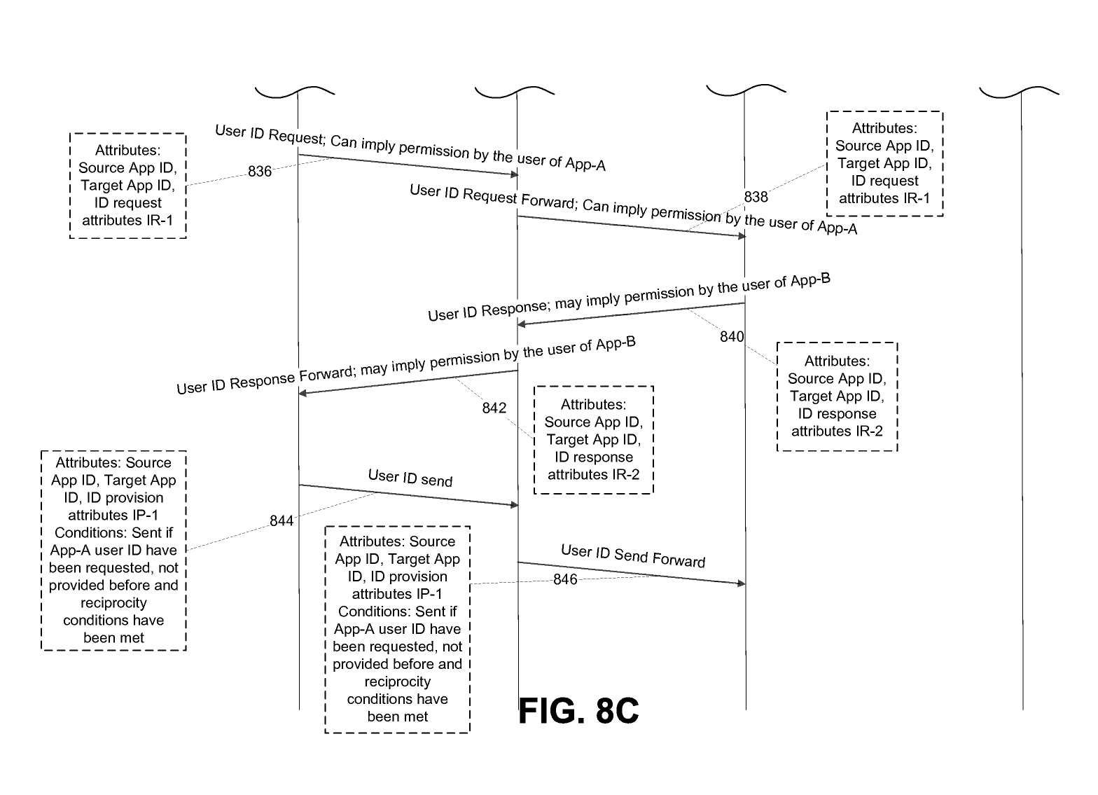

FIGS. 8A, 8B, and 8C collectively comprise a message flow diagram illustrating message flow between the applications and the broker in accordance with one exemplary untrusted broker embodiment. In these figures, the attributes and conditions, if any, of each message are shown within the diagrams in the text boxes having dashed outlines and connected to the reference numeral corresponding to the message to which it pertains.

Application A commences the process by sending a Grouping Initiation Request message 810 to the broker. The Grouping Initiation Request message includes an ID of application A. If application A knows one or more target applications that it wishes to query, then the Grouping Initiation Request message 810 may include one or more target application IDs. If, on the other hand, the particular embodiment does not allow an application to specify target applications to be queried or at least gives applications the option to not so specify, and allows the broker to determine the target applications that will be queried, then the target application ID may be omitted. The broker then sends Grouping Initiation Request Forward messages 812, 814 to the target application or applications as specified in the Grouping Initiation Request 810 and/or as determined by the broker, as the case may be. In this case, the broker sends the Grouping Initiation Request Forward message to application B 805 and application C 807. The Grouping Initiation Request Forward messages 812, 814 include the source application ID and the broker ID. Next, the target application(s) respond. In the example illustrated here, application C 807 does not wish to participate. In this particular embodiment, applications that do not wish to participate simply do not respond. However, in other embodiments, they may respond with a message indicating that they do not wish to participate.

On the other hand, application B does wish to participate and therefore sends a Grouping Initiation Agree message 816 to the broker. This message includes the source application ID (application A) as well as its own ID (application B). The broker 803 essentially forwards this response in a Grouping Initiation Agree Notification message 818 to application A. If payment to the broker is required at this time, then the broker and the applications negotiate payment to the broker (820). Payment may be processed in any reasonable manner and is not discussed in more detail herein. Also at this point, application A 801 and application B 805 may create and exchange shared keys for encrypting at least the attributes that will be exchanged between the two applications so as to conceal those attributes from the broker 803 (822). The creation and sharing of the keys may be conducted in any reasonable manner, such as using GBA, and is not described in further detail herein.

Also, if there is to be some form of payment between the applications themselves for participating in the matching process, the applications A and B may negotiate and execute payment between themselves at this point also (824). Again, the negotiation and execution of payment may be performed in a conventional manner and is not described in further detail herein.

Once at least one application has agreed to participate in the process, then application A sends a Grouping Request 826 to the broker 803 specifying the grouping parameters (GP-1) for use in the matching process. A Grouping Request message can be sent at any time after the two (or more) applications have agreed to participate in the process. The Grouping Request message also may include the source application ID and the target application ID for purposes of identification and for allowing the broker to forward the messages to the proper applications. Table 1 below shows an exemplary set of grouping parameters GP-1 for the grouping request. As shown, it includes a message sequence number, which may be used to update keys, among other things. Optionally, it may include a profile format attribute that indicates the format used to convey user profiles. This attribute is unnecessary if there is only one possible format. The grouping parameters may further include security parameters to indicate which keys are used to encrypt profile attributes. The grouping parameters optionally may also include an anonymized source user ID of the user that issued the grouping request. Alternately, the anonymized user ID may be sent in a later message, as there may be no need for the user ID as of this time. Also, if, in a particular embodiment, the user IDs are not to be anonymized, then this attribute need not be included in the grouping parameters.

TABLE 1
Grouping parameters GP-1 for untrustworthy Broker

| Attribute | | | |
|---|---|---|---|
| name | Attribute information | Optionality | Encryption¹ |
| Message | Used to update keys, etc. | Mandatory | None |
| sequence | | | |
| number | | | |
| Profile | Indicates the format used to convey user | Optional (used e.g. if more | None |
| format | profiles | than one are supported) | |
| Security | Indicates which keys are used to encrypt | Optional (used if multiple | None |
| parameters | (some) profile attributes | sets of keys have been | |
| | | generated) | |
| Source User | Anonymized identity of source user for | Optional - may be used as | None |
| ID - | comparison | an interim for full user | |
| Anonymized | | identity exchange | |
| Target | Profile (set of attributes and their relative | Mandatory but weights are | Yes. Each |
| (requested) | weights) used for matching | optional | field is |
| profile | | | independently |
| | | | encrypted. |
| Match | Used to determine if there is a match | Optional (default is used if | None |
| threshold | | not sent) | |

The grouping parameters GP-1 further includes the target profile, i.e. the set of attributes and their relative weights to be used for matching. In this exemplary embodiment (of an un-trusted broker, at least this attribute is encrypted. If the embodiment includes the use of a matching threshold that may be specified by the requesting application, then such a threshold should be included in the grouping parameters GP-1.

The broker then sends a grouping request forward message 828 to application B containing essentially the same information contained in the grouping request 826. Application B processes the request and determines if it has any users with sufficiently matching attributes (not shown) and, if so, sends a Grouping Response message 830 back to the broker 803. In some embodiments, if application B does not find a match, it may send no response to the broker, which the broker will interpret as meaning that no match was found. In other embodiments, when the target application does not find a match, it sends a Grouping Response message indicating that no match was found. The Grouping Response message 830 includes the source application ID, target application ID and a grouping response GR-2. Table 2 below illustrates the attributes of an exemplary grouping response GR-2. As shown, it includes a copy of the message sequence number from the grouping request message 826. It also includes an anonymized target user ID. It may further include the matching profile or profiles that it identified. However, it is not necessarily required that the matching profiles be sent at this time. It could be reserved for sending at a later time, for instance, after the users have agreed to exchange true user IDs. These attributes should be encrypted in the case of an untrusted broker. The message may also include a match score attribute indicating the level (or quality) of the match. If multiple matches were found, then, in one exemplary embodiment, the responding server may send each match in a separate message, each including a multiple matches index to distinguish each response from the others. In other embodiments, multiple matches could be sent in a single message in which the GR-2 parameters may include multiple target user IDs, target profiles, and match scores.

TABLE 2
Grouping response GR-2 attributes for untrustworthy Broker

| Attribute | | | |
|---|---|---|---|
| name | Attribute information | Optionality | Encryption¹ |
| Message | The sequence number matches the one in the | mandatory | None |
| sequence | request | | |
| number | | | |
| Profile | Omitted | | |
| format | | | |
| Security | Omitted | | |
| parameters | | | |
| Target User | Anonymized identity of target user with match | Optional - may be used as | None |
| ID - | | an interim for full user | |
| Anonymized | | identity exchange | |
| Target | Profile (set of attributes and their relative | Optional | Yes. Each |
| (found) | weights) that resulted in the match | | field is |
| profile | | | independently |
| | | | encrypted. |
| Match score | Used to compare with match threshold. Match | Optional but is required if | None |
| | score = 0 indicates no match | Target (found) profile not | |
| | | used | |
| Multiple | Used if multiple matches are returned per | Optional | |
| matches | request | | |
| index | | | |

The broker 803 then forwards this information to application A 801 in a match response notify message 832, which contains essentially the same information as described above in connection with the match response message 830.

At this point, both application A and application B are aware of an anonymized match. If at least one of the users now wishes to obtain the other's actual identity (the identity as used by the respective application, the process will continue as shown.

First, if payment is required for exchanging user IDs, then that may be negotiated (834) using conventional mechanisms or otherwise.

As previously mentioned, in some embodiments, permission to disclose true identities is implied if a match is found. However, in other embodiments, permission to exchange identities is negotiated at this point. This latter type of embodiment is illustrated in FIGS. 8A-8C. Particularly, one of the applications (shown as application A 801 in this example, but it could be either application A or application B) sends a user ID request 836 to the broker 803. The user ID request 836 includes the source application ID and the target application ID for purposes of routing as well as ID request attributes IR-1. Table 3 below shows an exemplary set of ID request attributes IR-1. As shown, they include a message sequence number, which can be used, inter a/ia, to update keys. They also may include the requesting user's as well as the target user's anonymized IDs, which can be stored and used as tags for subsequent interactions between the two users.

The IR attributes may further include an identity request flag that, when set, indicates that the application is requesting the other user's identity. This flag may be unnecessary if the message identifies itself as an identity request message in some other fashion. The identity request attributes may further include a user permission certificate to create a paper trail that the requesting application user has agreed to disclose its own true identity. This attribute would be included in embodiments in which the sending of a user ID request message 832 is intended to implicitly constitute an agreement to disclose one's own identity. Otherwise, it may be omitted and the agreement to share one's own identity may be negotiated at a later stage.

If payment is to be made prior to exchanging identities, then a payment certificate may be included.

Finally, the requesting user's ID may be included in this message, for instance, in embodiments in which the user that sent the user ID request 832 wishes to send its own actual user ID without first requiring a reciprocal commitment from the target application.

The broker 803 then forwards the user ID request message 838 to the target application 805.

TABLE 3
Identity request attributes IR-1 for untrustworthy Broker

| Attribute | | | |
|---|---|---|---|
| name | Attribute information | Optionality | Encryption |
| Message | Used to update keys, etc. | mandatory | None |
| sequence | | | |
| number | | | |
| Requesting | Used as a tag | Mandatory | None |
| user's | | | |
| anonymized | | | |
| ID | | | |
| Responding | Used as a tag | Mandatory | None |
| User | | | |
| Anonymized | | | |
| ID | | | |
| Identity | Indicates that other App user identity is | Optional, sent if desired | None |
| request flag | requested | | |
| User | Used to create a paper trail that App-1 user has | Optional. If not used, | None |
| permission | agreed to identity disclosure | recipient may or may not | |
| certificate | | agree to share their own | |
| | | identity | |
| Payment | Used to pay for identity of App-2 user | Optional, used if payment | None |
| certificate | | has been requested | |
| User ID | True user identity under App | Optional. May be sent if | Encrypted |
| | | reciprocal identity sharing | |
| | | isn't required | |

The target application 805 responds to the broker with a user ID response message 840. This user ID response message includes the source application ID, target application ID, and ID response attributes IR-2. In some embodiments, this message may constitute implicit permission by the user of application B to disclose the user's true identity to the other application, e.g., when the other application included a user permission certificate in the identity request attributes (as shown in Table 3) of the identity request message 836 or where reciprocity is not required. Table 4 below shows an exemplary set of ID response attributes IR-2. The attributes are largely the same attributes as the attributes contained in the identity request IR-1 (shown in table 3), except pertaining to application B. the User ID would be sent only if the proper conditions are met, e.g., (1) reciprocity for the disclosure of the true user ID is not required, (2) a user permission certificate has been received, (3) the other user has already disclosed her/her user ID, and/or (4) the user of Application B agrees to disclose his/her user ID.

TABLE 4
Identity response attributes IR-2 for untrustworthy Broker

| Attribute | | | |
|---|---|---|---|
| name | Attribute information | Optionality | Encryption¹ |
| Message | Matches received sequence number | Mandatory | None |
| sequence | | | |
| number | | | |
| Requesting | Used as a tag | Mandatory | None |
| user's | | | |
| anonymized | | | |
| ID | | | |
| Responding | Used as a tag | Mandatory | None |
| User | | | |
| Anonymized | | | |
| ID | | | |
| Identity | Indicates that other App user identity is | Optional, sent if desired | None |
| request flag | requested | | |
| User | Used to create a paper trail that App-2 user has | Optional. If not used, user | None |
| permission | agreed to identity disclosure | has not provided | |
| certificate | | permission | |
| User ID | True user identity under App | Optional. May be sent if | Encrypted |
| | | certificate received or if not | |
| | | required | |
| Payment | Used to pay for identity of App-1 user | Optional, used if payment | None |
| certificate | | has been requested | |

The broker 803 then forwards the user ID response (message 842) to the initiating application 801.

Finally, if the user ID request message 836 did not include the true identity of User A, then Application A will send it to the Broker at this time in a User ID send message 844. The Broker will forward the User ID send message to Application B (message 846).

The User ID Send messages 844 and 846 include the source application ID, the target application ID, and ID provisional attributes, IP-1. Table 5 below shows an exemplary set of ID provision attributes IP-1. As shown, they include (1) a message sequence number, which may be used to update keys, among other things, (2) the requesting user's anonymized ID, (3) the responding user's anonymized ID (both of which may be used as tags), and (4) the true user identity of the application sending this message.

TABLE 5
Identity provision attributes IP-1 for untrustworthy Broker

| Attribute | | | |
|---|---|---|---|
| name | Attribute information | Optionality | Encryption¹ |
| Message | Used to update keys, etc. | mandatory | None |
| sequence | | | |
| number | | | |
| Requesting | Used as a tag | Mandatory | None |
| user's | | | |
| anonymized | | | |
| ID | | | |
| Responding | Used as a tag | Mandatory | None |
| User | | | |
| Anonymized | | | |
| ID | | | |
| User ID | True user identity under App | Mandatory | Encrypted |

Please note that the encryption referenced in Tables 1-5 refers to encryption between the two applications (i.e., that the Broker isn't privy to). It does not pertain to encryption between each application and the Broker, which might typically be provided for communications in general.

### 2. Example 2

### Counterpart Applications Cannot be Trusted with Attribute Information, but Broker can be Trusted

In certain example procedures (e.g. and/or with certain applications), the Broker may be considered trustworthy and in other procedures/other applications the Broker 711 may not be considered trustworthy. In Example 1 above, attributes were freely exchanged (although permanent identities may initially not be exchanged) between the applications 715a, 715b but concealed from the Broker 711. This example, on the other hand, illustrates an exemplary embodiment in which the user attributes are shared between each application 715a or 715b and the Broker 711 (i.e., the Broker is trusted), but are not initially shared between the applications (users 701a, 701b or applications 715a, 715b that do not initially trust each other).

Before any groupings may be performed, applications 715a, 715b should share their respective databases (at least portions thereof) with the Broker 711, for example, to build a combined database. The combined database need not physically reside at the Broker. The Broker may have access to the information residing at an application's database or storage entity. In certain representative embodiments, the data and/or information may reside at the Broker and the following representative procedure may be implemented at the Broker. In the database: (1) attributes may be stored using the native application format or may converted to a common format (for example, a common format dictated by or associated with the Broker); and/or (2) attributes may be tagged by a random user identifier (for example, with the mapping between that random user identifier and a permanent user identifier being known to (e.g., only known to) the owner application.

In certain representative embodiments, data exchanges between the applications 715a, 715b and the Broker 711 may be encrypted. In other embodiments, there may be no communication directly between the applications.

In certain representative embodiments, the procedures may begin when User A at WTRU 715a requests a grouping from her application, AppA 715a. The Broker 711 may select applications based on its own criteria, which embodiments would allow the Broker to keep queried applications anonymous to prevent applications from contacting each other directly and bypassing the Broker. Alternately or additionally, AppA 715a may identify other applications of interest. The Broker 711 may compare the attribute set received from AppA to those of users of the selected applications, e.g., AppB 715b and AppC (not shown). If the databases reside at the owner applications, the Broker may communicate with those databases to conduct the search (e.g., query), if the applications agree. Payment may be provided at this point (usually by the querying application), for example, in the form of a payment certificate. The procedure may be repeated with User B 701b and application AppB 715b. Any number of such Users may be included in the procedure as bilateral interactions.

The Broker may be configured in a star configuration where, e.g., User A has been grouped with users B and C, but Users B and C may not be grouped or may not yet be grouped. The procedures may be repeated multiple times to achieve multilateral grouping.

Upon finding a match, the Broker may notify both applications of the match. The applications may request permission to share information, such as the attributes being matched between users, from their respective users prior to sharing permanent identities. If the identities of the applications themselves have been withheld from their counterparts, the identities may be provided to their counterparts after a match has been found or when authorized by the users. Before a user identity and/or an application identity is provided, the applications may exchange payment credentials. The credentials may be obtained from a third party by the payer and confirmed by the payee. Both side (e.g., User A or User B) may be the payer, and the matter may be negotiated between the applications through the Broker.

The procedure from the Broker's point of view may include the following. Applications share respective information from their databases with a Broker (the data may reside at the Broker or may be retrievable by the Broker from the applications or a third party).

Communications are not sent directly between the applications.

If AppA requests a grouping, the query contents and their representation may be as discussed herein. The Broker may select which other applications to group with and may perform the comparison, for example after requesting the application's/user's permission. The Broker may notify both applications of any matches. Payment to the Broker, if any, may be negotiated at this point (and may be performed by exchange of payment certificates). It is understood that there may be different payment models and this representative procedure is an example. Additionally, if there is to be any payment between the applications, that may be negotiated and performed at this time also. User identities, if obfuscated up to now, may be exchanged (e.g., at this point).

a. Limited Combined Databases

In certain embodiments, an application may agree to allow searching in only a subset of the data in each profile at first (with potential for searching the remainder of the profile subsequently—e.g., possibly based on permission being given). A preliminary limited search may be conducted to determine the subset. In one embodiment, each user profile may be partitioned into “shareable” and “non-shareable” portions. One may comprise be the shareable portions of user profiles and a second one may comprise the non-shareable portions. The databases for match searching in accordance with the principals disclosed herein may be created using the shareable portion only and a mapping may exist between the shareable and non-shareable portions at the owner applications so that the original database can be reconstructed, as needed.

A search over the shared portion of the profiles may be used to determine which profiles should be tagged for more extensive searching through the entire profile (i.e., including the shareable and non-shareable portions). For instance, the application that owns the database that is being searched may decide to give permission to the searching application as a function of the search results of the non-shareable portion of the database.

In other embodiments, applications may agree to allow searching in a subset of the database only (i.e. over a limited number of profiles).

b. Representative Application Advertisement

As previously noted, applications that belong to different entities (e.g., have different owners) may or may not know about each other and generally may not know how to conduct searches within each others' user databases.

Likewise, a Broker may not be able to determine which applications store data in which other applications may be interested.

Representative procedures may be implemented to enable servers (which may host applications) to advertise themselves over IP, for example, using Border Gateway Protocol (BGP), so that it is known how to access the servers and/or the applications. A Broker may access any of these known applications and may inquire regarding the type of user data that the applications and corresponding databases may store. The applications may respond with information that may include: (1) application identifier for future reference; (2) the size of the information repository (e.g., in users, bytes, sensors, and/or cars, among others). If a single application stores different types of data about different entities, these may be independent repositories and may be advertised as such; (3) the kind of information held for each (e.g., hobbies, and/or measurements).

There may be several ways by which repository information could be shared, including, for example, providing a frequency map of descriptor usage (e.g. 495 references of “cooking”). In certain representative embodiments, some of the profiles may be described using syntactical rules. Comparison of applications using different syntax may include the use of Functional Syntax Scores (FSS). Based on the above, the Broker may forward queries between applications. For example, using such a procedure, a Broker may learn about various applications and, for example the type of information that is in their databases. The procedure may start after the Broker has found which applications exist and how to address them.

In certain representative embodiments, as an advertisement and/or as a response to a Broker's query, the applications may respond with information that may include the size of database (e.g., in number of users, bytes, and/or sensors) and the kind or type of the information held for each database that responds. For example, a frequency map of various descriptors appearing in the database may be provided regarding the database (e.g., with or without actually sharing the descriptors, for example during the initially process or overall). In one example, a flat database (e.g., with no “categories”) may be implemented where each profile has an attached list of descriptors. A count of the relative frequency (for example, defined as a number of appearances of the descriptor divided by the total number of descriptors for all users) may be stored or calculated when requested for each descriptor in the database. For example, a database that includes profiles of engineers' skillsets may include 300 appearances of “LTE” and 200 appearances of “physical layer”. Categorization and syntax may complicate the categorization of a database and FSS may be used for the scoring process.

c. Exemplary Signal Flow for a Trusted Broker Embodiment

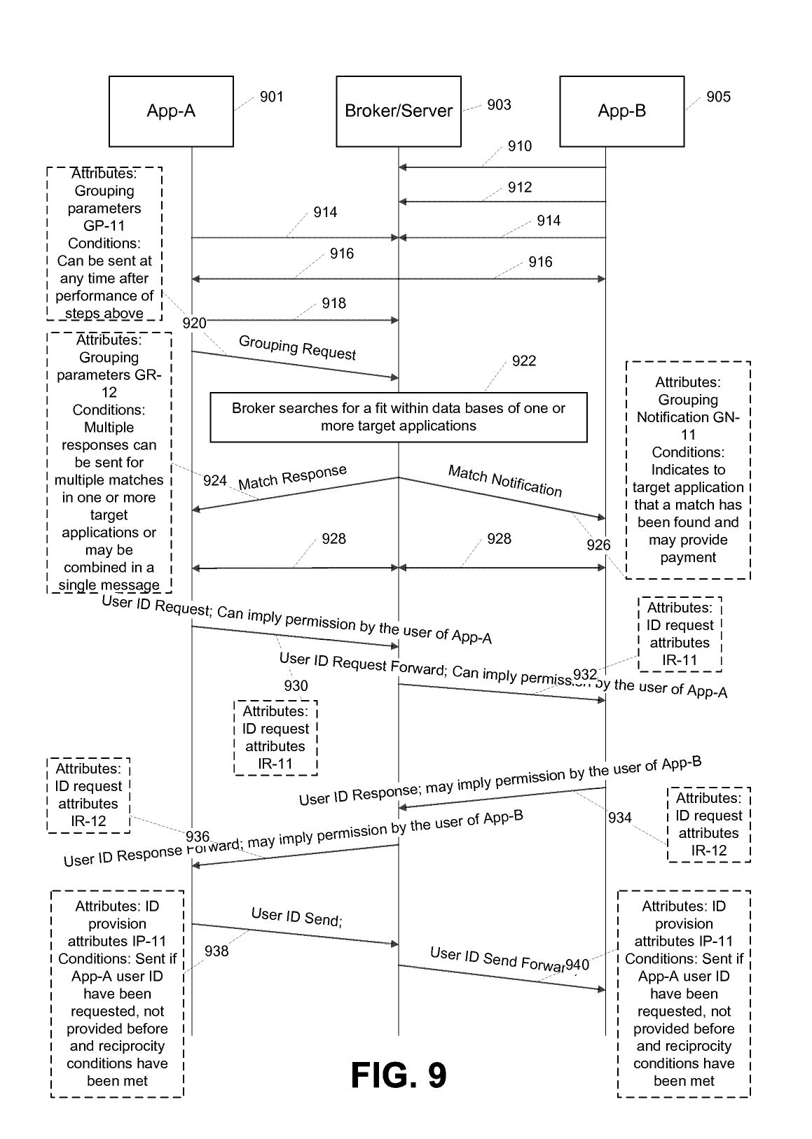

FIGS. 9A, 9B, and 9C collectively comprise a message flow diagram illustrating message flow between the applications and the broker in accordance with one exemplary trusted broker embodiment. In these figures, the attributes and conditions, if any, of each message are shown within the diagrams in the text boxes having dashed outlines and connected to the reference numeral corresponding to the message to which it pertains.

Initially, or each of the applications 901 and 905 and the broker 903 advertise their presence and basic services to each other so that they are aware of each other and their basic services. This is assumed at the beginning of the diagram and is not depicted.

Any application that wishes to participate in a grouping may advertise its database to the broker. Thus for instance, application B 905 sends a database advertisement 910 to the broker 903. This advertisement may include statistical descriptors of the database. The database advertisement may be sent as an unsolicited advertisement or, alternately, as a response to a query by a broker (not shown in the figure).

As discussed above, an application that is going to share its database with the broker for purposes of the grouping process should establish with the broker the means by which the broker can search in that applications database. For instance, reference numeral 912 in FIG. 9 generally represents a negotiation between the broker 903 and application B 905 for this purpose. A similar process might be conducted in connection with application A or any other application interested in participating, but is not shown in the figure. The identities of the actual users may be anonymized in the database so that the broker cannot determine the true identities of the users. The application would maintain a mapping between the anonymized user IDs and the true user IDs in such a case.

Furthermore, each application negotiates a separate set of keys with the broker to be used between itself and the broker. Profile formats, security parameters, etc. may also be negotiated at this point. This is represented in the figure for applications A and B as message exchanges 914.

The broker 903 defines a unique ID for each application 901 and 905 and sends a message 916 to each of those applications disclosing the unique ID that the broker assigned to that application.

If payment by any application(s) to the broker is required, then the broker and the applications negotiate payment to the broker at this time. For instance, FIG. 9 illustrates a payment negotiation between application A 901 and the broker 903 at 918. Payment may be processed in any reasonable manner and is not discussed in more detail herein.

Grouping may now commence. For instance, application A 901 sends a grouping request 920 to the broker 903 specifying the grouping parameters (GP-11) for use in the matching process. A grouping request can be sent at any time after the application has agreed with the Broker to participate in grouping processes. The Grouping Request messages 920 are somewhat similar to the Grouping Request messages 826 discussed above in connection with FIGS. 8A-8C. Table 6 below shows an exemplary set of grouping parameters GP-11 for the grouping request. As shown, it includes a message sequence number, which may be used to update keys and identity response messages, among other things. It also includes the source application ID as defined by the broker and may include a target application ID (also as defined by the broker). A target application ID would only be included if the requesting application 901 somehow know was the ID of a particular target application it wishes to query, such as may be the case as a result of previous transactions with that other application. Otherwise or additionally, the broker will determine which databases (which other applications) to search through in connection with this particular grouping request.

Grouping parameters GP-11 may also include an anonymized source user ID (for use when doing the comparison).

The grouping parameters GP-11 further include a target profile, i.e. the set of attributes and their relative weights to be used for matching. If the embodiment includes the use of a matching threshold that may be specified by the requesting application, then such a threshold may also be included in the grouping parameters GP-11.

TABLE 6
Grouping parameters GP-11 for trustworthy Broker

| Attribute name | Attribute information | Optionality |
|---|---|---|
| Message | Used to update keys, identify | mandatory |
| sequence number | response messages, etc. | |
| Source App ID | The ID of the source App as defined | Mandatory |
| | by Broker | |
| Target App ID | The ID, as defined by Broker, of the | Optional. Sent if target App ID |
| | target App for comparison | is known e.g. as a result of |
| | | previous transactions |
| Source User ID - | Anonymized identity of source user | Optional - may be used as an |
| Anonymized | for comparison | interim for full user identity |
| | | exchange |
| Target (requested) | Profile (set of attributes and their | Mandatory but weights are |
| profile | relative weights) used for matching | optional |
| Match threshold | Used to determine if there is a | Optional (default is used if not |
| | match | sent) |
| Payment | Certificate (s) of payment that can | Optional (sent if payment is a |
| certificate | be passed along to target App (s) | condition of match) |

When the broker 903 receives a grouping request, it performs a search within the databases of the one or more target applications (922). When completed, it will transmit a Match Response 924 to application A 901. The Grouping Response message 924 includes a grouping response GR-2. Table 7 below illustrates the attributes of an exemplary grouping response GR-2. As shown, it includes a copy of the message sequence number from the Grouping Request message 826. It optionally may also include the source application ID, target application ID and an anonymized target user ID. The source application ID may be omitted if addressing makes its identity unambiguous. The target application ID need not be provided, but may be provided in the Grouping Response message 924 so that the source application 901 can use it later in subsequent grouping requests such as discussed above in connection with the target application ID that may be included in the Grouping Request message 920 (see Table 6).

It may further include the matching profile or profiles that it identified. However, it is not necessarily required that the matching profiles be sent at this time. It could be reserved for sending at a later time, for instance, after the users have agreed to exchange true user IDs. The message may also include a match score attribute indicating the level (or quality) of the match. If multiple matches were found, then the GR-2 parameters may include multiple target user IDs, target profiles, and match scores. Alternately, each match may be sent in a separate message and the GR-12 attributes may further include a multiple matches index that differs for each match so that the multiple matching profiles can be distinguished from each other (i.e., multiple matches result in multiple Grouping Response messages. Alternately, reporting of multiple matches may be consolidated into a single message.

TABLE 7
Grouping response GR-12 attributes for trustworthy Broker

| | Attribute name | Attribute information | Optionality |
|---|---|---|---|
| 0 | Message sequence | The sequence number matches | mandatory |
| | number | the one in the request | |
| 1 | Source App ID | Identifies the source of initial | Optional - may be omitted |
| | | grouping request | if addressing makes |
| | | | identity unambiguous |
| 2 | Target App ID | Identity App where match was | Optional - may be used |
| | | found | by source in subsequent |
| | | | grouping requests |
| 3 | Target User ID - | Anonymized identity of target | Optional - may be used |
| | Anonymized | user with match | as an interim for full user |
| | | | identity exchange |
| 4 | Target (found) profile | Profile (set of attributes and | Optional |
| | | their relative weights) that | |
| | | resulted in the match | |
| 5 | Match score | Used to compare with match | Optional but is required if |
| | | threshold. Match score = 0 | Target (found) profile not |
| | | indicates no match | used |
| 6 | Multiple matches | Used if multiple matches are | Optional |
| | index | returned per request | |

The Broker then transmits a Match Notification message 926 to the application that provided a matching profile, application B 905 in this example. This indicates to the target application that matches were found in its database and may provide payment. The Match Notification message 926 includes grouping notification attributes GN-11 as illustrated in Table 8 below. Particularly, it includes a message sequence number and the source application ID (i.e., application B 905). It may further optionally include the target application ID if the target application is known, for example, as a result of previous transactions. It optionally may also include one or more anonymized source user IDs of the users that matched the request profile. The target user ID (whether anonymized or not) is not absolutely necessary at this time and may be sent at a later time.

The message 926 may also include one or more match score attributes indicating the level (or quality) of the match. The GR-12 attributes optionally may further include a multiple matches index to differentiate different matching profiles from each other, as discussed above in connection with the Grouping Response message 830.

TABLE 8
Grouping Notification GN-11 for trustworthy Broker

| Attribute name | Attribute information | Optionality |
|---|---|---|
| Message | Used to update keys, etc. | mandatory |
| sequence | | |
| number | | |
| Source App ID | The ID of the source App as defined by | Mandatory |
| | Broker | |
| Target App ID | The ID, as defined by Broker, of the | Optional. Sent if target App ID |
| | target App for comparison | is known e.g. as a result of |
| | | previous transactions |
| Source User ID - | Anonymized identity of source user for | Optional - may be used as an |
| Anonymized | comparison | interim for full user identity |
| | | exchange |
| Match Score | Indicates quality of match | Optional |
| Payment | Certificate of payment that was sent | Optional (sent if payment is a |
| certificate | from source App | condition of match) |

At this point, both applications A and B are aware of an anonymized match. They are not aware of the identity of the other application unless that information has been agreed to be disclosed. If it has not been agreed to be disclosed, it may be so agreed at this point or at any later time.

Similarly to the embodiment discussed above in connection with FIGS. 8A-8C, in some embodiments, permission to disclose true identities is implied if a match is found. However, in other embodiments, permission to exchange identities is negotiated at this point. The remainder of the messaging shown in FIGS. 9A-9C pertains to the situation where it is necessary to negotiate identity exchange at this time. Particularly, one of the applications (shown as application A 901 in this example, but it could be either application A or application B) sends a User ID request 930 to the broker 903. Table 9 below shows an exemplary set of ID request attributes IR-11 for this embodiment. As shown, they include a message sequence number, the source application ID, the target application ID, the requesting user's anonymized ID, and the responding user's anonymized ID, all of which can be used as tags.

The IR-11 attributes may further include an identity request flag that, when set, indicates that the application is requesting the other user's identity. The flag may not be needed if the message includes some other means of indicating that the message is a User ID Request message. The identity request attributes may further include a user permission certificate to create a paper trail that the requesting application 901 user has agreed to disclose its own true identity. This attribute would be included in embodiments in which the sending of a User ID Request message 832 is intended to implicitly constitute an agreement to disclose one's own identity. Otherwise, it may be omitted and the agreement to share one's own identity may be negotiated at a later stage.

If payment is to be made prior to exchanging identities, then a payment certificate may be included.

Finally, the requesting user's ID may be included in this message, for instance, in embodiments in which the user that sent the user ID request 832 wishes to send its own actual user ID without first requiring a reciprocal commitment from the target application.

The broker 903 then sends a message 932 forwarding the User ID Request information to the target application 905.

TABLE 9
Identity request attributes IR-11 for trustworthy Broker

| Attribute name | Attribute information | Optionality |
|---|---|---|
| Message | Used to update keys, etc. | mandatory |
| sequence | | |
| number | | |
| Source App ID | Used as tag | mandatory |
| Target App ID | Used as tag | mandatory |
| Requesting | Used as a tag | Mandatory |
| user's | | |
| anonymized ID | | |
| Responding | Used as a tag | Mandatory |
| User | | |
| Anonymized ID | | |
| Identity request | Indicates that other App user identity is | Optional, sent if desired |
| flag | requested | |
| User | Used to create a paper trail that App-1 | Optional. If not used, recipient |
| permission | user has agreed to identity disclosure | may or may not agree to share |
| certificate | | their own identity |
| Payment | Used to pay for identity of App-2 user | Optional, used if payment has |
| certificate | | been requested |
| User ID | True user identity under App | Optional. May be sent if |
| | | reciprocal identity sharing isn't |
| | | required |

The target application 905 responds to the broker with a User ID Response message 934. This User ID Response message includes ID response attributes IR-12 as illustrated in Table 10 below. In some embodiments, this message may constitute implicit permission by the user of application B to disclose the user's true identity to the other application, e.g., embodiments in which the other application included a user permission certificate in the identity request attributes (as shown in Table 9) of the Identity Request message 930 or where reciprocity is not required. Table 10 below shows an exemplary set of ID response attributes IR-12. The attributes are largely the same attributes as the attributes contained in the identity request IR-11 (shown in table 9), except pertaining to application B.

TABLE 10
Identity response attributes IR-12 for trustworthy Broker

| Attribute name | Attribute information | Optionality |
|---|---|---|
| Message | Matches received sequence number | mandatory |
| sequence | | |
| number | | |
| Source App ID | Used as a tag | Mandatory |
| Target App ID | Used as a tag | Mandatory |
| Requesting | Used as a tag | Mandatory |
| user's | | |
| anonymized ID | | |
| Responding | Used as a tag | Mandatory |
| User | | |
| Anonymized ID | | |
| Identity request | Indicates that other App user identity is | Optional, sent if desired |
| flag | requested | |
| User | Used to create a paper trail that App-2 | Optional. If not used, user has |
| permission | user has agreed to identity disclosure | not provided permission |
| certificate | | |
| User ID | True user identity under App | Optional. May be sent if |
| | | certificate received or if not |
| | | required |
| Payment | Used to pay for identity of App-1 user | Optional, used if payment has |
| certificate | | been requested |

The broker 903 then sends a message 936 forwarding the user ID Response information to the initiating application 901.

Finally, if the User ID Request message 930 did not include the true identity of User A, then Application A may send it to the Broker at this time in a User ID Send message 938. The Broker will then send a message 940 forwarding the User ID Send message information to Application B.

The User ID Send messages 938 and 940 identity response attributes, IR-11, as illustrated in Table 11 below. As shown, they include (1) a message sequence number, which may be used to update keys, among other things, (2) the source application's ID, (3), the target application's ID, (4) the requesting user's anonymized ID, (5) the responding user's anonymized ID, and (6) the true user identity of the user of the application A that is sending this message.

TABLE 11
Identity provision attributes IP-11 for trustworthy Broker

| Attribute name | Attribute information | Optionality |
|---|---|---|
| Message | Used to update keys, etc. | mandatory |
| sequence | | |
| number | | |
| Source App ID | Used as a tag | Mandatory |
| Target App ID, | Used as a tag | Mandatory |
| Requesting | Used as a tag | Mandatory |
| user's | | |
| anonymized ID | | |
| Responding | Used as a tag | Mandatory |
| User | | |
| Anonymized ID | | |
| User ID | True user identity under App | Mandatory |

Much, if not all, of the messages and/or attributes described hereinabove for the various exemplary brokered embodiments are also applicable to the embodiments in the preceding sections related to direct communication between the application servers without the use of a broker.

### C. Representative Discovery Procedures for Grouped Users

Following the procedures set forth herein for grouping, at least two users may be aware of the identity of each other (e.g., as defined by one or more different applications). The users may be interested in discovering whether and/or when they are in logical and/or physical proximity of each other. Users may be defined to be in logical proximity when they can exchange information with each other through a network or through networks. For example, two users may be in logical proximity when a data connection between them is enabled.

While discovery procedures are described herein in connection with embodiments following grouping, it should be understood that these discovery concepts, apparatus, methods, and implementations also may be implemented independently of the grouping procedures.

In certain representative embodiments, the user's identities (e.g., as defined by one or more applications) for to at least two users may be mutually obtained for the proximity determination.

1. Representative Logical Proximity Discovery Procedures

In certain representative embodiments, a logical proximity discovery procedure may start when one of the users (e.g., User A) indicates that the User A wants to discover another user or users that have been previously grouped (e.g., User B). AppA may indicate an initiation of a discovery procedure to AppB using an anonymized identity obtained previously (or any other anonymized identity agreed between the AppA and the AppB). In other embodiments, a permanent user identity may be used. AppA may send the identity along with the following information: (1) whether or not a standardized ProSe process is to be used for the discovery process; and/or (2) a mobile network operator (MNO) identity (e.g., ATT or Verizon, among others) and an identifier obtained from the MNO, which may be referred to as ProSe ID (e.g., if a standardized ProSe discovery process is used), among others. The ProSe ID may be unique within the operator's network. The ProSe ID may be used when physical proximity discovery via ProSe is requested and may be postponed until the physical proximity discovery is requested.

If User B agrees (e.g., to continue the process based on the information received), application AppB may send the corresponding information/material. Both users and/or both applications may agree on the method for discovery. At this point, the two applications, AppA and AppB, may use the keys established between themselves in other procedures to exchange identities which may be used to establish communications between themselves with the operator or without involving the operator (e.g., over the top). If they have not previously exchanged keys, they may do so at this time. The identifiers that may be exchanged may include Mobile Subscriber-Integrated Services Digital Network Numbers (MS-ISDNs), Session Initiation Protocol-Uniform Resource Identifiers (SIP-URIs), and/or other identities. This step may or may not involve the Broker. Generally, if a Broker has been used for grouping it may continue to be used to bridge between the applications. The Broker may or may not be privy to the identifiers and may only know that the identifiers have been exchanged. In certain representative embodiments, if the identities are not encrypted, they may help in enforcing payment for brokerage services.

2. Representative Physical Proximity Discovery Procedures

Physical proximity discovery procedures may be performed with or without operator network support in a standardized manner.

a. Representative Physical Proximity without Involving the Operator(s) Network(s)

Both applications may obtain from the mobile devices (e.g., a WTRU or UE) User location information, which may be obtained from: (1) GPS; (2) a third party location service (e.g. those available through some cellular providers); and/or (3) camped and alternate cell information.

The applications may either exchange the data directly (e.g., if a Broker is not used) or may send the data via the Broker (e.g., if a Broker is used). It may be encrypted or unencrypted.

The Broker and/or both applications may compare location data and may determine proximity. If proximity is not indicated based on the location data, the procedure may be repeated, for example, based on an event trigger or a condition trigger. For example, a trigger for repeating the location comparison may be based on: (1) a time change, (2) a location change, (3) an event trigger, and/or (4) a condition trigger, among others.

When the two UEs or other mobile devices are judged to be in proximity and if direct communication between the WTRUs is required, the respective WiFi Direct™ (or any other applicable access mechanism) may be configured with some or all of the following parameters: (1) a determination of which of the pair of UEs will be deemed the AP and which will be deemed the STA; and/or (2) an SSID and/or password (for example, the SSID and password may be determined using a hashing function known to both sides based on a concatenation of the two anonymized identities obtained previously). The SSID and/or password may be unique to within a small probability of collision and may be designed so that it cannot be used to trace back the identities by an entity listening to the transmission. Collisions may happen as a result of the concatenation and the second discovery stage with a full identifier may be used to prevent a further collision. WiFi Direct may proceed to handle MAC level discovery and communication link setup at the request of one or more of the respective applications.

b. Representative Physical Proximity Using ProSe

This procedure may use the ProSe identifiers obtained in the logical proximity discovery, for example, as follows.

If a Broker is used between the applications, the Broker may send ProSe identifiers of both users to the MNO. The operators' networks may already be aware of the network identities of these UEs and may use the information to indicate discovery.

In certain representative embodiments, if a Broker is not used, each application may send to the MNO both users' application identities and ProSe identities. The MNO or MNOS may pair the users via their application identities. The ProSe identifier of, e.g., WTRU A given by the MNO to Application A, received via Application B alongside ProSe identifier for WTRU B and vice versa may be taken by the mobile network to imply mutual permission across applications, thus allowing inter-Application proximity discovery.

C. Representative Procedures to Compare Attributes

Looking for matches by tags or keywords without human intervention may be difficult. Within one application, users may be forced to choose or may choose from within a structured dictionary for words that describe the tags or keywords. This may not be desirable as users may prefer to describe themselves in their own words. In addition, between two applications, a single (e.g., common) structured dictionary may not be possible without prior arrangements. Also, to accurately categorize tags or keywords, dependent characteristics may be used. For example, Bob may indicate an interest in football, which may not indicate the type of interest. That is, the interest may be as a spectator or Bob may be playing in a recreational league. To indicate the former, Bob may categorize football under “pastime”, “hobbies” and/or “fan”. To indicate the latter, Bob may use terms such as “sports”, “athletic (activity)” and/or “fitness”. It is contemplated that, in some cases, the same words may be used to describe different categories.

In certain representative embodiments, an attribute set may be standardized and users may select properties from fixed menus. Comparison between applications for the standardized attribute set may be straightforward and readily understood by one of skill in the art. In other representative embodiments, procedures may be implemented to compare attributes, keywords, and/or tags when a standard (e.g., fixed) attribute set is not used between such applications. Instead, a dictionary, may exist and can be used to translate between the two applications.

Many procedures are possible for the comparison. The procedures may be based on rules and/or dictionaries (e.g., grammatical (syntactical) rules and dictionaries). The rules may provide a mechanism for exploiting the relationships between terms used as parts of attributes. Dictionaries that include a list of synonyms may allow similar concepts that are described by different words to be matched. The grammatical rules may be based on (e.g., loosely based on) language rules. The grammatical rules may be a subset of rules that may be used for the purpose.

1. Representative Terminology and Notations

The following terminology may be used to represent elements of a user's profile.
1) A descriptor is a basic property of the profile. Descriptors are denoted with uppercase letters (e.g., ‘A’, ‘B’ or ‘FOOTBALL’). When letters are used, quotation marks may be omitted for brevity.
2) A nested descriptor (also referred to as a child descriptor) is one in which the meaning depends on the parent descriptor. A nested relationship is denoted as follows: when A and C are nested under B it is denoted as ‘B’(‘A’,‘C’). Any number of nested levels is possible, although the descriptors herein may be limited to two levels for clarity.
3) A modifier is a descriptor that may change the meaning of a descriptor it is adjacent to, (e.g., creating in effect a compound descriptor). Modifiers are denoted as ‘A’&‘B’ such that the former modifies the latter (e.g., ‘MODERN’&‘BALLET’ or ‘A’&‘B’).
4) A qualifier indicates a level of application of the descriptor to the person (e.g., “high”, “avid,” or “slight”). Qualifiers are denoted with lowercase letters (e.g., ‘a’ or ‘high’). The qualifier precedes its descriptor and is denoted as ‘a’/‘B’. Qualifiers for compound descriptors are understood to qualify the compound and are denoted as ‘a’/‘B’&‘C’, which is equivalent to ‘a’/(‘B’&‘C’).
5) Two descriptors may be synonyms if their respective meanings are the same or are sufficiently close. Synonymous relationship are indicated as ‘A’˜‘B’ or ‘a’˜‘b’. A level of closeness, hereinafter sometimes called a synonymy measure, may be attached to the relationship, in which case the synonymous relationship may be denoted as ‘a’˜(σ)‘b’ where −1≦σ≦1. Negative values may be used for a and, if so, may imply or correspond to antonyms. The dictionary may include compound descriptors (e.g., ‘a’˜(‘b’&‘c’). For comparison purposes, a threshold for synonymy, Θ, may be defined, whereas a, b are synonyms, if a ˜(σ)b and σ≧Θ.
6) A dictionary may be a list of synonyms. Synonyms may depend on their father descriptor, if any. For example, ‘FOOTBALL’ under ‘FITNESS’ may not be a synonym with ‘FOOTBALL’ under ‘ENTERTAINMENT’. To define both as synonyms, they may have to be entered twice into the dictionary.
7) A profile may contain or include a list of items as described hereinabove. The order of the list may not matter as long as nested, modifier, and/or qualifier ordering is kept. Profiles may be denoted as (e.g., {A} or {Bob}).
8) The set of all synonyms of descriptor A or qualifier b may be denoted A″ and b″, respectively. For example A″=[B, C, D].

Many syntactical systems can be agreed upon between applications or between applications and brokers.

As an example, the following syntactical relationships are contemplated:
(I) ‘a’˜‘b’ is the same as ‘a’˜(1)‘b’, likewise A˜B is equivalent to A˜(1) B;
(II) synonymy is transitive, e.g., if ‘a’˜(σ1)‘b’ and ‘b’˜(σ2)‘c’ then ‘a’˜(σ1σ2)‘c’;
(III) A, B=B, A;
(IV) ‘a’/‘B’&‘C’=‘a’/(‘B’&‘C’) (e.g. ‘avid’/(‘THEATER’&‘GOER’);
(V) D&F≠F&D (e.g. “AMERICAN”&“INDIAN”≠“INDIAN”& “AMERICAN”);
(VI) A(B)≠B(A);
(VII) A(B, C)=A(B), A(C).

The following are examples of valid profile formats that are all equivalent under the syntactical rules above:

{A}={A,B,C(E,D&F,a/G,b/H&I)}={C(a/G,D&F,b/H&I,E),B,A}={C(a/G),C(D&F),C(b/H&I),C(E),B,A}.

2. Sample Procedure Using a Preexisting Dictionary

A first example assumes that a centralized (e.g., common) dictionary exists that may be used for comparison. The common dictionary may reside on some server, for instance. In some embodiments, respective applications may each use a local copy of the dictionary where the local copies are synchronized frequently.

Comparing profiles {A} and {B} may consist of or include the following (note that the versions need not actually be created except for purposes of the comparison process). This notation is used for illustration only:
1. Replace each descriptor in the profile with a set of some or all of its known synonyms (including itself), for example, to create multiple versions such that, in each of the versions, one of the descriptors, modifiers, or qualifiers may be replaced with a different synonym. A version of profile {A} will be referred to as {A}k.
2. For each {A}k and {B}j,
   a. Initialize a match score to gauge the similarity of each k, j combination,
   b. Simplify each expression using the following properties:

A(B,C)=A(B),A(C)
c. For each coma-separated descriptor (or compound descriptor and qualifier) in {A}k, check for a counterpart in {B}j using the relationships mentioned above in the preceding section (relationships (I) through (VII) under item 8 under the section Representative Terminology and Notations immediately above. For each descriptor, add a value equal to the relevant synonymy measure, a, to the match score. As noted above, the synonymy measure may be a normalized value between −1 and 1, with negative numbers indicating words that are substantially antonyms and positive numbers indicating words that are substantially synonyms. Thus, in this embodiment, the match score is not an integer. If specific attribute weights have been defined for descriptors (preferably as a normalized value between 0 and 1), then the synonymy measure may be multiplied by the applicable attribute weight before adding it in the match score.
d. Select (k,j) combination with highest match score.
3. Compare to threshold if provided.

3. Representative Modifications for When there is no Preexisting Common Dictionary

Applications AA and BB may use their own synonym dictionaries. In this case, the dictionary of each application may be sent to the other application with the query. In certain representative embodiments, the exchange of the respective dictionaries may be facilitated by the Broker, which may store each of the exchanged dictionaries to possibly reduce communications. To interpret a query, an application may use the transitive nature of synonymy.

4. Applications with Different Syntax Rules

a. Creating a Common Dictionary

A particular thesaurus (e.g., an English thesaurus) may serve as an agreed dictionary of synonyms. While there may be some differences between different publishers or editions, it is contemplated that such differences should not have a large impact. In certain representative embodiments, a thesaurus may not be sufficient or may be irrelevant. For example, when describing a person's professional expertise, industry-accepted terms may be used that may not or cannot be found in a thesaurus.

Two applications may create an agreed upon dictionary of synonyms using the following.
(a) The two applications may negotiate (e.g., if they are to use a standard thesaurus), that one of their respective dictionaries is to become the standard thesaurus, or a common thesaurus may be produced from the two dictionaries and/or other dictionary information.
(b) The two applications may use the agreed dictionary.
(c) In certain representative embodiments, if the applications decide to produce a common dictionary, they may do so using the following procedure:
   1) One of the applications (e.g. application AA) may send its dictionary D_{AA}(0) to application BB.
   2) Dictionaries may be shared using a list with entries of the general form:

‘aₘ’˜(σₘ₁)‘aₘ₁’, . . . ,˜(σₘₖ)‘aₘₖ’
Where ‘aₘ₁’ through ‘aₘₖ’ are synonyms of ‘aₘ’ with a level of synonymy σₘ₁ through σₘₖ (it is contemplated that the number of synonyms of each item can vary). As described above, synonymy is reciprocal so the list may be supplied in one direction or both directions.
3) Application BB may compare it to its own dictionary and may return a suggested modified dictionary D_{BB}(0) using, for example, the following rules:
   a. If word ‘aₘ’ does not appear in its dictionary, it is not likely used in its profile repository. Hence, the word may be marked as ‘aₘ’˜φ (empty set).
   b. Words ‘bₘ’ that are not in D_{AA}(0) are added into D_{BB}(0) and marked as φ.
   c. Words that appear in both dictionaries may be examined for their lists of synonyms to generate a compromise meaning along the following lines:
   If (1) ‘aₘ’=‘bₖ’ and, (2) in D_{AA}(0), ‘aₘ’˜(σₘᵢ)‘aₘᵢ’, and (3) in D_{BB}(0) ‘bₖ’˜(σₖⱼ)‘bₖⱼ’, the following rules may be applied:
      (i) If there is no i such that ‘aₘᵢ’≠‘bₖⱼ’ (i.e., if they are not exact equivalents), the latter may be added to the list, e.g., now ‘aₘ’˜(σₖⱼ)‘bₖⱼ’, (e.g., a synonym is added to the list);
      (ii) If ‘aₘᵢ’=‘bₖⱼ’ but σₖⱼ≠σₘᵢ, (i.e. the synonym appears in both dictionary but at a different synonymy level) a compromise σ may substituted for σₖⱼ (e.g., the geometrical mean of σₖⱼ and σₘᵢ);
      (iii) If ‘aₘᵢ’=‘bₖⱼ’ and σₖⱼ=σₘᵢ, then nothing need be done because this means that the latter is already on the list with the same synonymy measure

Additions to the dictionary may be tracked.

Application AA may accept or reject changes and a further modified dictionary, DAA(1), may be sent to Application BB. The process may continue until there are no more modifications.

Certain representative embodiments may use Converged Address Book (CAB) queries, which are understood by one of skill the art.

Certain representative embodiments may use an extensible encoding mechanism for string and their matching rules for query and response interactions. Strings may have any value or meaning and may be concatenated.

### V. CONCLUSION

The contents of the following: (1) the publication entitled “Converged Address Book Requirements” publish on the Internet at http://technical.openmobilealliance.org/Technical/release_program/docs/CopyrightClick.aspx?pck=CAB&file=V1_0-20121113-A/OMA-RD-CAB-V1_0-20121113-A.pdf; (2) the publication entitled “One way functions” published on the Internet at http://en.wikipedia.org/wiki/One-way_function; (3) the publication entitled “Service advertisement using BGP” published on the Internet at http://vww.ietf.org/proceedings/85/slides/slides-85-idr-6, are each incorporated by reference herein.

Although features and elements are described above in particular combinations, one of ordinary skill in the art will appreciate that each feature or element can be used alone or in any combination with the other features and elements. In addition, the methods described herein may be implemented in a computer program, software, or firmware incorporated in a computer readable medium for execution by a computer or processor. Examples of non-transitory computer-readable storage media include, but are not limited to, a read only memory (ROM), random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU 102, UE, terminal, base station, RNC, or any host computer.

Moreover, in the embodiments described above, processing platforms, computing systems, controllers, and other devices containing processors are noted. These devices may contain at least one Central Processing Unit (“CPU”) and memory. In accordance with the practices of persons skilled in the art of computer programming, reference to acts and symbolic representations of operations or instructions may be performed by the various CPUs and memories. Such acts and operations or instructions may be referred to as being “executed,” “computer executed” or “CPU executed.”

One of ordinary skill in the art will appreciate that the acts and symbolically represented operations or instructions include the manipulation of electrical signals by the CPU. An electrical system represents data bits that can cause a resulting transformation or reduction of the electrical signals and the maintenance of data bits at memory locations in a memory system to thereby reconfigure or otherwise alter the CPU's operation, as well as other processing of signals. The memory locations where data bits are maintained are physical locations that have particular electrical, magnetic, optical, or organic properties corresponding to or representative of the data bits. It should be understood that the exemplary embodiments are not limited to the above-mentioned platforms or CPUs and that other platforms and CPUs may support the provided methods.

The data bits may also be maintained on a computer readable medium including magnetic disks, optical disks, and any other volatile (e.g., Random Access Memory (“RAM”)) or non-volatile (e.g., Read-Only Memory (“ROM”)) mass storage system readable by the CPU. The computer readable medium may include cooperating or interconnected computer readable medium, which exist exclusively on the processing system or are distributed among multiple interconnected processing systems that may be local or remote to the processing system. It is understood that the representative embodiments are not limited to the above-mentioned memories and that other platforms and memories may support the described methods.

In an illustrative embodiment, any of the operations, processes, etc. described herein may be implemented as computer-readable instructions stored on a computer-readable medium. The computer-readable instructions may be executed by a processor of a mobile unit, a network element, and/or any other computing device.

There is little distinction left between hardware and software implementations of aspects of systems. The use of hardware or software is generally (but not always, in that in certain contexts, the choice between hardware and software may become significant) a design choice representing cost vs. efficiency tradeoffs. There may be various vehicles by which processes and/or systems and/or other technologies described herein may be effected (e.g., hardware, software, and/or firmware), and the preferred vehicle may vary with the context in which the processes and/or systems and/or other technologies are deployed. For example, if an implementer determines that speed and accuracy are paramount, the implementer may opt for a mainly hardware and/or firmware vehicle. If flexibility is paramount, the implementer may opt for a mainly software implementation. Alternatively, the implementer may opt for some combination of hardware, software, and/or firmware.

The foregoing detailed description has set forth various embodiments of the devices and/or processes via the use of block diagrams, flowcharts, and/or examples. Insofar as such block diagrams, flowcharts, and/or examples contain one or more functions and/or operations, it will be understood by those within the art that each function and/or operation within such block diagrams, flowcharts, or examples may be implemented, individually and/or collectively, by a wide range of hardware, software, firmware, or virtually any combination thereof. Suitable processors include, by way of example, a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Application Specific Standard Products (ASSPs); Field Programmable Gate Arrays (FPGAs) circuits, any other type of integrated circuit (IC), and/or a state machine.

The present disclosure is not to be limited in terms of the particular embodiments described in this application, which are intended as illustrations of various aspects. Many modifications and variations may be made without departing from its spirit and scope, as will be apparent to those skilled in the art. No element, act, or instruction used in the description of the present application should be construed as critical or essential to the invention unless explicitly provided as such. Functionally equivalent methods and apparatuses within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is to be understood that this disclosure is not limited to particular methods or systems.

It is also to be understood that the terminology used herein is for the purpose of describing particular embodiments only, and is not intended to be limiting. As used herein, when referred to herein, the terms “user equipment” and its abbreviation “UE” may mean (i) a wireless transmit and/or receive unit (WTRU), such as described infra; (ii) any of a number of embodiments of a WTRU, such as described infra; (iii) a wireless-capable and/or wired-capable (e.g., tetherable) device configured with, inter alia, some or all structures and functionality of a WTRU, such as described infra; (iii) a wireless-capable and/or wired-capable device configured with less than all structures and functionality of a WTRU, such as described infra; or (iv) the like. Details of an example WTRU, which may be representative of any UE recited herein, are provided below with respect to FIGS. 1-5.

In certain representative embodiments, several portions of the subject matter described herein may be implemented via Application Specific Integrated Circuits (ASICs), Field Programmable Gate Arrays (FPGAs), digital signal processors (DSPs), and/or other integrated formats. However, those skilled in the art will recognize that some aspects of the embodiments disclosed herein, in whole or in part, may be equivalently implemented in integrated circuits, as one or more computer programs running on one or more computers (e.g., as one or more programs running on one or more computer systems), as one or more programs running on one or more processors (e.g., as one or more programs running on one or more microprocessors), as firmware, or as virtually any combination thereof, and that designing the circuitry and/or writing the code for the software and or firmware would be well within the skill of one of skill in the art in light of this disclosure. In addition, those skilled in the art will appreciate that the mechanisms of the subject matter described herein may be distributed as a program product in a variety of forms, and that an illustrative embodiment of the subject matter described herein applies regardless of the particular type of signal bearing medium used to actually carry out the distribution. Examples of a signal bearing medium include, but are not limited to, the following: a recordable type medium such as a floppy disk, a hard disk drive, a CD, a DVD, a digital tape, a computer memory, etc., and a transmission type medium such as a digital and/or an analog communication medium (e.g., a fiber optic cable, a waveguide, a wired communications link, a wireless communication link, etc.).

The herein described subject matter sometimes illustrates different components contained within, or connected with, different other components. It is to be understood that such depicted architectures are merely examples, and that in fact many other architectures may be implemented which achieve the same functionality. In a conceptual sense, any arrangement of components to achieve the same functionality is effectively “associated” such that the desired functionality may be achieved. Hence, any two components herein combined to achieve a particular functionality may be seen as “associated with” each other such that the desired functionality is achieved, irrespective of architectures or intermediate components. Likewise, any two components so associated may also be viewed as being “operably connected”, or “operably coupled”, to each other to achieve the desired functionality, and any two components capable of being so associated may also be viewed as being “operably couplable” to each other to achieve the desired functionality. Specific examples of operably couplable include but are not limited to physically mateable and/or physically interacting components and/or wirelessly interactable and/or wirelessly interacting components and/or logically interacting and/or logically interactable components.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, where only one item is intended, the term “single” or similar language may be used. As an aid to understanding, the following appended claims and/or the descriptions herein may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should be interpreted to mean “at least one” or “one or more”). The same holds true for the use of definite articles used to introduce claim recitations. In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.” Further, the terms “any of” followed by a listing of a plurality of items and/or a plurality of categories of items, as used herein, are intended to include “any of,” “any combination of,” “any multiple of,” and/or “any combination of” multiples of the items and/or the categories of items, individually or in conjunction with other items and/or other categories of items. Moreover, as used herein, the term “set” or “group” is intended to include any number of items, including zero. Additionally, as used herein, the term “number” is intended to include any number, including zero.

In addition, where features or aspects of the disclosure are described in terms of Markush groups, those skilled in the art will recognize that the disclosure is also thereby described in terms of any individual member or subgroup of members of the Markush group.

As will be understood by one skilled in the art, for any and all purposes, such as in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etc. As a non-limiting example, each range discussed herein may be readily broken down into a lower third, middle third and upper third, etc. As will also be understood by one skilled in the art all language such as “up to,” “at least,” “greater than,” “less than,” and the like includes the number recited and refers to ranges which can be subsequently broken down into subranges as discussed above. Finally, as will be understood by one skilled in the art, a range includes each individual member. Thus, for example, a group having 1-3 cells refers to groups having 1, 2, or 3 cells. Similarly, a group having 1-5 cells refers to groups having 1, 2, 3, 4, or 5 cells, and so forth.

Moreover, the claims should not be read as limited to the provided order or elements unless stated to that effect. In addition, use of the terms “means for” in any claim is intended to invoke 35 U.S.C. §112, ¶6 or means-plus-function claim format, and any claim without the terms “means for” is not so intended.

A processor in association with software may be used to implement a radio frequency transceiver for use in a wireless transmit receive unit (WTRU), user equipment (UE), terminal, base station, Mobility Management Entity (MME) or Evolved Packet Core (EPC), or any host computer. The WTRU may be used in conjunction with modules, implemented in hardware and/or software including a Software Defined Radio (SDR), and other components such as a camera, a video camera module, a videophone, a speakerphone, a vibration device, a speaker, a microphone, a television transceiver, a hands free headset, a keyboard, a Bluetooth® module, a frequency modulated (FM) radio unit, a Near Field Communication (NFC) Module, a liquid crystal display (LCD) display unit, an organic light-emitting diode (OLED) display unit, a digital music player, a media player, a video game player module, an Internet browser, and/or any Wireless Local Area Network (WLAN) or Ultra Wide Band (UWB) module.

Although the invention has been described in terms of communication systems, it is contemplated that the systems may be implemented in software on microprocessors/general purpose computers (not shown). In certain embodiments, one or more of the functions of the various components may be implemented in software that controls a general-purpose computer.

In addition, although the invention is illustrated and described herein with reference to specific embodiments, the invention is not intended to be limited to the details shown. Rather, various modifications may be made in the details within the scope and range of equivalents of the claims and without departing from the invention.

1. A method implemented in a node of a telecommunications network for grouping a plurality of users based on stored profiles of the users, the plurality of users operating on one or more networks, the method comprising:
obtaining access, via the one or more networks, to at least one database of user profiles maintained by at least a first entity (target entity);
receiving from a second entity (source entity), via the one or more networks, a grouping request message requesting a search of user profiles having attributes meeting at least one criterion set forth in the request;
searching the at least one database for user profiles meeting the at least one criterion;
transmitting a grouping response message to the source entity via the one or more networks, the grouping response message including an indicator that at least one user profile meeting the at least one criterion has been found;
receiving from the source entity, via the one or more networks, a user identity request message requesting an identity of the user associated with the at least one user profile meeting the at least one criterion (target user);
responsive to the user identity request message, transmitting to the target entity, via the one or more networks, a user identity request forward message requesting from the target entity the identity of the target user; and
receiving from the target entity, via the one or more networks, a user identity response message, the user identity response message including an identity of the target user.

2. (canceled)

3. The method of claim 1 wherein the user identity request message further includes at least one of: (1) an indication that a user associated with the grouping request message (source user) agrees to share the source user's identity with the target user if the target user agrees to share the target user's identity with the source user and (2) the source user's identity.

4. The method of claim 3 wherein the user identity request message further includes at least one of: (1) an anonymized identity of the source user, wherein the anonymized identity of the source user uniquely identifies the source user without disclosing an actual identity of the source user as maintained by the source entity; (2) an anonymized identity of the target user, wherein the anonymized identity of the target user uniquely identifies the target user without disclosing an actual identity of the target user as maintained by the target entity; (3) a source application identity, the source application identity specifying a software application associated with the source entity; and (4) a target application identity specifying a software application associated with the target entity.

5. The method of claim 1 further comprising:
receiving from the target entity, via the one or more networks, a user identity request message requesting an identity of a user associated with the grouping request message (source user);
responsive to the user identity request message, transmitting to the source entity, via the one or more networks, a user identity request forward message requesting from the source entity the identity of the source user; and
receiving from the source entity, via the one or more networks, a user identity response message, the user identity response message including an identity of the source user.

6. The method of claim 5 wherein the user identity request message further includes at least one of: (1) an indication that the target user agrees to share the target user's identity with the source user if the source user agrees to share the target user's identity with the source user and (2) the target user's identity.

7. The method of claim 6 wherein the user identity request message further includes at least one of: (1) an anonymized identity of the source user, wherein the anonymized identity of the source user uniquely identifies the source user without disclosing an actual identity of the source user as maintained by the source entity; (2) an anonymized identity of the target user wherein the anonymized identity of the target user uniquely identifies the target user without disclosing an actual identity of the target user as maintained by the target entity; (3) a source application identity, the source application identity specifying a software application associated with the source entity; and (4) a target application identity specifying a software application associated with the target entity.

8. The method of claim 1 wherein the grouping request message includes an anonymized user identity of a first user associated with the grouping request message (source user), wherein the anonymized identity of the source user uniquely identifies the source user without disclosing an actual identity of the source user as maintained by the source entity.

9. The method of claim 1 wherein the grouping response message includes an anonymized identity of the target user, wherein the anonymized identity of the target user uniquely identifies the target user without disclosing an actual identity of the target user as maintained by the target entity.

10. The method of claim 8 wherein the grouping request message further includes at least one of: (1) an anonymized identity of a first user associated with the grouping request (source user), wherein the anonymized identity of the source user uniquely identifies the source user without disclosing an actual identity of the source user as maintained by the source entity; (2) a match threshold, the match threshold specifying a level of similarity required between the at least one criterion and a user profile in order to declare that a user profile meets the at least one criterion; (3) a source application identity, the source application identity specifying a software application associated with the source entity; and (4) a target application identity specifying at least one software application in connection with which the searching should be performed.

11. The method of claim 10 wherein at least one of the target entity and the source entity is a social networking software application.

12. The method of claim 10 wherein the target entity and the source entity are different software applications and wherein the searching comprises:
determining synonymy of terms used to describe user profile attributes in the first software application with terms used to describe user profile attributes in the second software application; and
determining a measure of similarity between the at least one criterion and the attributes of user profiles in the at least one database using the determined synonymy of terms.

13. The method of claim 12 wherein the determining of synonymy comprises:
establishing a synonymy measure for terms used in the first application relative to terms used in the second application, wherein the synonymy measure indicates a level of synonymy between the terms used in the first application relative to terms used in the second application.

14. (canceled)

15. The method of claim 1 wherein the grouping response message further includes at least one of: (1) an anonymized identity of the source user, wherein the anonymized identity of the source user uniquely identifies the source user without disclosing an actual identity of the source user as maintained by the source entity; (2) a match score, the match score specifying a level of similarity between the at least one criterion and the user profile of the target user; (3) a source application identity, the source application identity specifying a software application associated with the source entity; and (4) a target application identity specifying a software application associated with the target entity.

16. The method of claim 1 further comprising:
transmitting a match notification message to the target entity via the one or more networks, the match notification message including an indicator that at least one user profile meeting the at least one criterion has been found.

17. The method of claim 16 wherein the match notification message further includes at least one of: (1) an anonymized identity of a user associated with the grouping request (source user), wherein an anonymized user identity uniquely identifies a user to which it corresponds without disclosing an actual identity of that user as maintained by the source entity; (2) a match score, the match score specifying a level of similarity between the at least one criterion and the user profile of the target user; (3) a source application identity, the source application identity specifying a software application associated with the source entity; and (4) a target application identity specifying a software application associated with the target entity.

18. (canceled)

19. A method implemented in a node of a telecommunications network for grouping a plurality of users based on stored profiles of the users, the plurality of users operating on one or more networks, the method comprising:
receiving from a source entity, via the one or more networks, a grouping request message requesting a search of user profiles having attributes meeting at least one criterion set forth in the request, wherein the at least one criterion is encrypted so that the node does not know the attributes in the request;
transmitting, via the one or more networks, a grouping request forward message to at least one target entity having a database of user profiles;
receiving, via the one or more networks, from the at least one target entity a grouping response message, the grouping response message including an indication of that a user profile of a user meeting the at least one criterion (target user) was located in the at least one target entity's database; and
transmitting a grouping response notification message to the source entity via the one or more networks, the grouping response notification message including an indicator that at least one user profile meeting the at least one criterion has been found.

20-27. (canceled)

28. The method of claim 19 further comprising:
receiving a grouping initiation request message from the source entity, via the one or more networks, the grouping initiation request message requesting the ability to issue grouping request messages to another entity;
responsive to the grouping initiation request message, transmitting to at least one second entity, including the target entity, a grouping initiation request forward message requesting of the at least one second entity the ability for the source entity to issue grouping request messages to the at least one second entity;
receiving from the at least one second entity a grouping agree message granting permission for the first entity to issue grouping request messages to the at least one second entity.

29. The method of claim 28 further comprising:
selecting the at least one second entity from a plurality of entities.

30. The method of claim 28 wherein the grouping initiation request message further comprises an identity of the source entity.

31. The method of claim 30 wherein the grouping initiation request message further comprises an indicator of at least one other entity desired to be the at least one target entity.

32. The method of claim 28 wherein the grouping agree message further comprises:
(1) an identification of the source entity and (20 an identification of the entity transmitting the grouping agree message.

33. The method of claim 28 further comprising the source entity and the target entity exchanging encryption keys.

34-48. (canceled)
